(19) United States
(12) Patent Application Publication
(10) Pub. No.: US 2012/0330849 A1
(43) Pub. Date: Dec. 27, 2012

(54) METHODS, APPARATUS, AND SYSTEMS FOR PERFORMING INSTALLATIONS OF ENGINEERED SYSTEMS AND GENERATING SITE VISIT MANIFESTS FOR SAME

(75) Inventors: Steven Nielsen, North Palm Beach, FL (US); Curtis Chambers, Palm Beach Gardens, FL (US); Jeffrey Farr, Tequesta, FL (US)

(73) Assignee: CertusView Technologies, LLC

(21) Appl. No.: 13/544,567

(22) Filed: Jul. 9, 2012

Related U.S. Application Data
(63) Continuation of application No. 13/456,178, filed on Apr. 25, 2012.
(60) Provisional application No. 61/499,998, filed on Jun. 22, 2011.

(51) Int. Cl. G06Q 10/06

(52) U.S. Cl. 705/301

(57) ABSTRACT

Improvements to an installation process for an engineered system involve consolidation of the number of visits to a work site by field staff and/or particular work performed in a given site visit. A site visit manifest is generated to provide electronic documentation of pre-installation and/or installation activity. Various types of electronic information may be generated and/or collected in connection with any of multiple possible phases of a given installation at a particular work site for purposes of generating a site visit manifest. Additionally, different information components of a site visit manifest may be selectively viewed/accessed (e.g., based on different levels of permission or access-rights) to facilitate one or more of review of the work performed, quality, productivity and/or cost assessments of same, and billing functions. Particular examples of improved processes relating to installation of Fiber to the Premises (FTTP) subscriber drops are provided.

### CROSS-REFERENCES TO RELATED APPLICATIONS

The application claims the benefit, under 35 U.S.C. §120, as a continuation (CON) of U.S. Non-provisional application Ser. No. 13/456,178, filed Apr. 25, 2012, entitled “Methods, Apparatus, and Systems for Performing Installations of Engineered Systems and Generating Site Visit Manifests for Same.” application Ser. No. 13/456,178 claims a priority benefit, under 35 U.S.C. §119(e), of U.S. Provisional Patent Application Ser. No. 61/499,998, filed on Jun. 22, 2011, entitled “Drop Construction System, Apparatus and Methods.” Each of the above-identified applications is hereby incorporated herein by reference.

### BACKGROUND

Field service operations may be any operation in which companies dispatch technicians and/or other staff to perform certain activities, for example, installations, services and/or repairs. Field service operations may exist in various industries, examples of which include, but are not limited to, utility installations, network installations, security systems, construction, medical equipment, heating, ventilating and air conditioning (HVAC) and the like.

Examples of field service operations relating generally to the construction industry involve various activities surrounding the installation of engineered systems, such as utilities (e.g., electricity service infrastructure, telecommunications/data services infrastructure, water/sewer infrastructure, natural gas infrastructure). The installation of engineered systems, and particularly utilities buried underground (also referred to as “underground facilities”), often requires a series of field operations performed by various field staff (e.g., field engineers, field technicians, excavation and installation contractors, etc.) over some period of time, and typically entails multiple visits by different field staff to one or more work sites implicated by the installation. For example, the installation of engineered systems such as underground facilities generally comprises a variety of pre-installation activity to facilitate the proper and effective installation of the system; such pre-installation activity also may ensure the integrity of any surrounding pre-existing (e.g., previously-installed) infrastructure, and mitigation of possible damage to same during excavation that may be attendant to the installation of a new utility.

Some early-stage field service operations often involved in the installation of an engineered system relate to an assessment of one or more work sites at which the system is to be installed, design of the system itself, and/or specification of at least some aspect of the installation process (e.g., equipment, personnel, timing, process, etc.). For purposes of the present disclosure, any of the foregoing early-stage operations is referred to generally as “pre-survey” activity (or simply a “pre-survey”). Pre-survey activity typically is performed by one or more field staff pursuant to a work order that specifies at least one work site at which the pre-survey activity is to be conducted. A work order may have a variety of content and formats, and may be issued in paper form or electronic form. In some instances, a work order may be in the form of an email or other electronic message sent to field staff (and received by the field staff's mobile telecommunications device). In general, the work order typically includes text information describing a work site (e.g., geographic information indicating a location of the work site, and a description specifying the extent/metes and bounds of the work site). Examples of geographic information relating to the work site that may be provided in a work order include, but are not limited to, alphanumeric information designating a street address, street intersection, geographic region or other map information (e.g., designating one or more particular map grids or grid coordinates of one or more facilities maps), as well as one or more GPS latitude/longitude coordinate pairs representing a location and/or extent of the work site. The work order may include other information regarding work scope (particulars regarding equipment to be installed and/or results to be achieved), duration (amount of time estimated to be needed to complete the plan), and cost estimates.

As noted above, upon receipt of a work order, field staff may perform various pre-survey activity at a work site specified in the work order in anticipation of installation of an engineered system. One type of pre-survey activity is sometimes referred to as a “dispatch,” during which field staff generally assess the work site to determine where underground utility infrastructure should be installed, and get a sense of the general work effort involved in the installation. During such a “dispatch,” field staff may observe terrain and landscaping conditions, a presence of one or more natural or manmade environmental landmarks (e.g., trees, boulders, utility poles, paved surfaces, curbs, etc.), existing above-ground structures and/or connection points to pre-existing underground infrastructure to which the new utility being installed is to be coupled, and the like. In some instances, a dispatch also may include “white lining,” in which field staff mark (on ground, pavement or other surface at the work site) where excavation (some type of disturbance of the ground, e.g., digging, trenching, boring) is required as part of the installation. This process is referred to as “white-lining,” as the field staff typically employ white paint and/or white flags as one or more physical survey marks placed on the ground, pavement or other surface to indicate one or more locations at which underground facility installation is planned. In many cases, the process of conventional white-lining involves circumscribing some area at a work site with a white paint outline in the shape a polygon (e.g., a rectangular box) to indicate a prospective dig area in which excavation may occur as part of an installation.

Another type of pre-survey activity (that may be performed pursuant to a work order) may involve the generation of an “engineering plan” by a field engineer to specify the design of an engineered system to be installed. Engineering plans documenting system design and installation particulars may be later used by installation/construction contractors in the field to identify and/or place (install) various system components at the work site. For example, in connection with telecommunication systems for television, telephone and/or data communications, technicians may use an engineering plan to identify where junction boxes, conduit, switches and other components are to be placed at a work site, perform necessary excavation or other preparation at the work site, and install the equipment appropriately.

One common technique for generating an engineering plan for an installation relating to a telecommunication system involves sending an engineer to a particular work site with one or more printed facilities maps that may include information such as existing streets and buildings, as well as pre-existing utility features, such as telephone poles, transformer and junction boxes, electrical lines, sewer and water lines or valves, and so on in the geographic area including and proximate to the work site. Using the facilities maps, the engineer may take notes either on the maps themselves or on a separate paper regarding where and how each component of the telecommunication system to be installed will be placed; in particular, the field engineer notes details of how the installation may be performed, such as materials to be used, types of installation techniques to be used in specific locations (e.g., direct bury in one area, pull-through in existing pipe in another), number of technicians recommended for performing the installation, etc. Thereafter, the engineer (or a drafts person) may use the notes to prepare the engineering plan in the form of a computer-aided design (CAD) drawing (or other drawing in electronic form) that defines the details for the telecommunication system installation. This engineering plan (which may include drawing elements as well as textual notes) can then be used for obtaining needed permits and approvals, as well as in a competitive bidding process, and ultimately actual installation of the telecommunication system at the work site.

Beyond “pre-survey” activity as described above, another type of field service operation relating to pre-installation activity for engineered systems (and particularly underground facilities) is referred to as a “locate and marking operation,” also commonly referred to more simply as a “locate operation” (or sometimes merely as a “locate”). In a typical locate operation, a locate technician visits a work site in which there is a plan to disturb the ground (e.g., excavate, dig one or more holes and/or trenches, bore, etc.) so as to determine a presence or an absence of one or more underground facilities in a dig area to be excavated or disturbed at the work site. In some instances, a locate operation may be requested for a “design” project (e.g., generation of an engineering plan), in which there may be no immediate plan to excavate or otherwise disturb the ground, but nonetheless information about a presence or absence of one or more underground facilities at a work site may be valuable to inform a planning, permitting and/or engineering design phase of a future construction project.

In many states, an excavator who plans to disturb ground at a work site is required by law to notify any potentially affected underground facility owners prior to undertaking an excavation activity. Advanced notice of excavation activities may be provided by an excavator (or another party) by contacting a “one-call center.” As part of an advanced notification, excavators typically provide to the one-call center various information relating to the planned activity, including a location (e.g., address) of the work site and a description of the dig area to be excavated or otherwise disturbed at the work site. An excavation notice also is commonly referred to as a “locate request,” and may be provided by the excavator to the one-call center via an electronic mail message, information entry via a website maintained by the one-call center, or a telephone conversation between the excavator and a human operator at the one-call center.

Using the information provided in a locate request, the one-call center identifies certain underground facilities that may be present at the indicated work site via a utility mapping database maintained by the one call center. Once facilities implicated by the locate request are identified, the one-call center generates a “locate request ticket” (also known as a “locate ticket,” or simply a “ticket”) and transmits the ticket to the owner(s) of any identified underground facilities. The locate request ticket essentially constitutes an instruction to inspect a work site, and typically identifies the work site of the proposed excavation or design and a description of the dig area, typically lists on the ticket all of the underground facilities that may be present at the work site, and may also include various other information relevant to the proposed excavation or design (e.g., the name of the excavation company, a name of a property owner or party contracting the excavation company to perform the excavation, etc.). The one-call center sends the ticket to one or more underground facility owners (and/or one or more locate service providers who may be acting as contracted agents of the facility owners) so that they can conduct a locate and marking operation to verify a presence or an absence of any underground facilities in the dig area.

In some instances, a given underground facility owner may operate its own fleet of locate technicians; alternatively, a given facility owner may contract with a locate service provider to receive locate request tickets and perform a locate and marking operation on their behalf in response to received tickets. In any event, upon receiving a ticket, a locate service provider or a facility owner (hereafter referred to as a “ticket recipient”) may dispatch a locate technician to the work site of planned excavation to determine a presence or absence of one or more underground facilities in the dig area to be excavated or otherwise disturbed. For situations in which there have been one or more previous visits to the work site relating to pre-survey activity such as “white-lining” (i.e., applying white paint and/or white flags as one or more physical survey marks on ground, pavement or other surface at the work site to indicate one or more locations at which new underground facility installation is planned), a locate technician dispatched to the work site may use the previous white-lining as a guide to their activities relating to the locate and marking operation.

A typical first step for the locate technician includes utilizing an underground facility “locate device,” which is an instrument or set of instruments (also referred to commonly as a “locate set”) for detecting facilities that are concealed in some manner, such as cables and pipes that are located underground. The locate device is employed by the technician to verify the presence or absence of underground facilities indicated in the locate request ticket as potentially present in the dig area. This process is often referred to as a “locate operation.”

In addition to the locate operation, the locate technician also generally performs a “marking operation,” in which the technician marks the presence (and in some cases the absence) of a given underground facility in the dig area based on the various signals detected (or not detected) during the locate operation. For this purpose, the locate technician conventionally utilizes a “marking device” to dispense a marking material on the ground, pavement, or other surface in and around the dig area/work site. Marking material may be any material, substance, compound, and/or element, used or which may be used separately or in combination to physically mark, signify, and/or indicate. Examples of marking materials may include, but are not limited to, paint, chalk, dye, and/or iron. Marking devices, such as paint marking wands and/or paint marking wheels, provide a convenient method of dispensing marking materials onto surfaces, such as onto the surface of the ground or pavement.

In some environments, arrows, flags, darts, or other types of physical objects may be used to mark the presence or absence of an underground facility in a dig area, in addition to or as an alternative to a material applied to the ground (such as paint, chalk, dye, tape). The marks resulting from any of a wide variety of materials and/or objects used to indicate a presence or absence of underground facilities generally are referred to as physical “locate marks.” Often, different color materials and/or physical objects may be used for locate marks, wherein different colors correspond to different utility types. For example, the American Public Works Association (APWA) has established a standardized color-coding system for utility identification for use by public agencies, utilities, contractors and various groups involved in ground excavation (e.g., red=electric power lines and cables; blue=potable water; orange=telecommunication lines; yellow=gas, oil, steam). In some cases, the technician also may provide one or more marks to indicate that no facility was found in the dig area (sometimes referred to as a “clear”).

As mentioned above, the foregoing activity of identifying and marking a presence or absence of one or more underground facilities generally is referred to for completeness as a “locate and marking operation.” However, in light of common parlance adopted in the construction industry, and/or for the sake of brevity, one or both of the respective locate and marking functions may be referred to in some instances simply as a “locate operation” or a “locate” (i.e., without making any specific reference to the marking function). Accordingly, it should be appreciated that any reference in the relevant arts to the task of a locate technician simply as a “locate operation” or a “locate” does not necessarily exclude the marking portion of the overall process. At the same time, in some contexts a locate operation is identified separately from a marking operation, wherein the former relates more specifically to detection-related activities and the latter relates more specifically to marking-related activities.

Following completion of the locate and marking operation, the locate technician “closes” the ticket and typically conveys the closed ticket to a supervisor or dispatcher. In some instances, the original ticket recipient notifies the one-call center that the locate and marking operation has been completed; in turn, the one-call center conveys to the party that submitted the original locate request that excavation may now proceed for the installation of the engineered system. In other instances, a particular time period is established in which a locate and marking operation is presumed to be performed following issuance of a ticket (e.g., within 48 hours of ticket issuance). In any event, upon notification by the one-call center of ticket completion, or after expiration of an established time period for performing locate and marking operations, field staff in the form of an excavation and/or installation crew may be dispatched to the work site to attend to various excavation and installation activities.

In some cases (based in part on the size of the installation job and/or type of engineered system being installed), separate excavation and installation crews may be dispatched in turn to the work site; alternatively, a single excavation/installation crew may be dispatched to the work site to attend to both excavation as may be required and installation of the engineered system. Upon arriving to the work site, the respective or collective excavation/installation crew may find one or more physical survey marks relating to white-lining conducted as part of the pre-survey activity, as well as one or more physical locate marks relating to the locate and marking operation; as noted above, the physical survey mark(s) and/or the physical locate mark(s) facilitate the proper and effective installation of the system, as well as ensure the integrity of any surrounding pre-existing infrastructure and mitigation of damage to same during excavation that may be attendant to the installation of a new utility. The excavation/installation crew(s) also may be provided with an engineering plan for the installation (if one is generated during pre-survey activity, as discussed above). Pursuant to the installation process, an installation crew may in some cases generate a record or drawing of the installation (e.g., by marking up an engineering plan), which record or drawing is sometimes referred to as “as-built” documentation. Such “as-built” documentation may include various information relating to locations of installed underground facilities, measurements of excavations performed, and/or amounts of materials used (e.g., for billing purposes).

In recent years, telecommunication systems have seen significant expansion as important engineered systems. Telecommunication systems provide one or more of commercial TV services, Internet data services, and voice services (“Voice-over-Internet Protocol,” or VoIP) to one or more subscriber premises (or “end users”) in a given geographic area. Generally speaking, a telecommunication system refers to the operational (e.g., geographical) footprint of an entertainment and/or information services franchise that provides entertainment and/or information services to a subscriber base spanning one or more towns, a metropolitan area, or a portion thereof. Some large cable companies operate several telecommunication systems (e.g., in some cases up to hundreds of systems), and are known generally as Multiple System Operators (MSOs).

Telecommunication systems often employ fiber optic cables (bundles of hair-thin glass strands) and may in some instances also employ electrical conductors in the form of coaxial cables as part of the system infrastructure. This infrastructure may be deployed above-ground (e.g., via telephone poles) and/or underground. Telecommunication infrastructure conventionally is implemented in a variety of arrangements, in part determined by how close fiber optic cables are installed to subscriber premises. Exemplary infrastructure architectures include “Fiber to the Neighborhood” (FTTN) (also sometimes referred to as “Fiber to the Feeder” or FTTF), “Fiber to the Curb” (FTTC), and Fiber to the Premises (FTTP) (also sometimes referred to as “Fiber to the Home” or FTTH).

In an FTTN/FTTF or FTTC node, a fiber optic cable infrastructure is employed as the physical communication medium to communicate information to the general geographic area of a particular subscriber neighborhood. Within the subscriber neighborhood, coaxial cable is employed as the physical communication medium between the fiber optic cable infrastructure and respective subscriber premises. In an FTTC node, the fiber optic cable infrastructure generally comes closer to the premises in the neighborhood than in an FTTN/FTTF node. Unlike telecommunication systems employing FTTN/FTTF and FTTC neighborhood nodes, FTTP systems have a primarily fiber optic cable infrastructure that runs directly to respective subscriber premises.

In FTTP systems, laser-generated pulses of light travel along fiber optic cables directly to subscriber premises to transmit voice, data and video signals. FIG. 1 illustrates an example of a conventional FTTP system 10. As shown in FIG. 1, an FTTP system 10 typically includes an optical line terminal 16 and a circuit or packet switch 14 located in a central switching office 12 (also referred to as a “headend”) serving as a point of origination for FTTP transmissions coming into and out of a wider-area (e.g., national) network 15. A main fiber optic cable feed 22 is coupled to the optical line terminal 16 and traverses a geographic area including multiple subscribers 26 of the FTTP system 10. The FTTP system 10 also includes one or more optical splitters 18, coupled to the main fiber optic cable feed 22, which serve as connection points to the main fiber feed in a particular neighborhood or development served by the FTTP system. The optical splitters allow for splitting and combining of signals between the main fiber optic cable feed and respective fiber optic cable feeds 24 to multiple subscriber premises; these respective feeds 24 to individual subscriber premises sometimes are referred to as fiber optic “drops” (also referred to in some instances as “cable drops,” “subscriber drops,” or “telecommunications drops”). Each subscriber premises of the FTTP system includes an optical network terminal 20 which serves as a termination point for the subscriber drop, where received optical signals are converted into voice, data or video feeds to equipment in the subscriber's premises (and where information to be transmitted from the subscriber premises back to the central switching office 12 is converted to optical signals).

In the system shown in FIG. 1, when a new subscriber is to be added to the FTTP system, typically a new subscriber drop 24 must be installed between an optical splitter 18 of the FTTP system and the new subscriber's premises. Such drops often are deployed underground and, as such, involve some type of disturbance of the ground, i.e., excavation, as part of the installation process. When a telecommunication system operator receives a request for a new subscription, typically the operator issues to an installation contractor a work order identifying the work site for the proposed subscriber drop. The installation contractor then undertakes a multi-step installation process typically involving some type of pre-survey activity, one or more locate and marking operations, and ultimately excavation/installation activity to deploy the subscriber drop. As noted above, the overall installation process for the subscriber drop conventionally involves multiple visits to the work site by different field staff/field crews (e.g., pre-survey field technicians/field engineers; locate technicians; excavation/installation contractors).

### SUMMARY

The inventors have recognized and appreciated that conventional installation processes for engineered systems, typically requiring sending different field staff on multiple visits to a work site at which installation is planned, may involve undue delay and/or inefficient use of resources. Such delays and inefficiencies in turn may lead to frustration and dissatisfaction from those parties relying on the installation of new engineered systems (or portions thereof).

More specifically, in connection with the installation of new fiber optic cable drops for “Fiber to the Premises” (FTTP) systems, conventional multi-step/multi-crew processes for pre-installation and installation activity can cause an undesirably long delay from the time that an initial request for an FTTP installation is received until the FTTP installation is completed. Such delays may be correlated to a cancellation rate of prospective subscribers to the FTTP system; for example, if an FTTP installation involving a new fiber optic drop to a subscriber premises takes three days to complete from the time of placing a request for new FTTP services, it is estimated that prospective subscribers are 30% more likely to cancel their request for the new FTTP services; similarly, if such an installation process is not completed within five days of a request for new services, it is estimated that prospective subscribers are 80% more likely to cancel their request for the new FTTP services.

In view of the foregoing, various inventive embodiments disclosed herein relate to improved methods, apparatus and systems for performing installations of engineered systems, and generating “site visit manifests” for such installations. As noted above, “engineered systems” as used herein generally refers to various types of utilities (e.g., electricity service infrastructure, telecommunications/data services infrastructure, water/sewer infrastructure, natural gas infrastructure). Different portions of such engineered systems may be installed above ground or below ground; utilities buried underground are referred to herein as “underground facilities.” While many of the concepts disclosed herein may be particularly germane to improving an installation process for underground facilities, it should be appreciated that the inventive embodiments described herein are not limited in this respect, and may apply similarly to above-ground installations of at least some portion of an engineered system. Also, while some embodiments described herein are directed to FTTP installations (e.g., installation of new FTTP services involving a new drop to a subscriber premises), it should be appreciated that the inventive embodiments disclosed herein are not limited in this respect, and may apply similarly to installations of other types of underground facilities and, more generally, other types of engineered systems.

In one aspect, examples of improved methods described herein involve some degree of consolidation of the number of site visits to a work site of a planned installation, and/or consolidation of particular work performed in a given site visit, so as to improve the efficiency and/or other aspects of the installation process. Examples of improvements to the installation process facilitated by the inventive concepts disclosed herein include, but are not limited to: reduction of time required to assess a work site of a planned installation, design an engineered system or a portion thereof to be installed, perform any necessary excavation, and/or complete the installation; reduction of field staff needed to perform one or more phases of the installation process, and/or utilization of less-expensive (and/or less highly-trained) field staff to perform more complex functions with the aid of more sophisticated tools/computing devices; reduction of “turn-around time” between request for new services and installation of engineered system infrastructure to provide requested services.

To achieve the foregoing improvements, in some embodiments disclosed herein both pre-survey activity (e.g., “dispatch,” “white-lining,” generation of an engineering plan) as well as locate and marking operations may be performed during a single visit to a work site, by tandem staff respectively responsible for the pre-survey activity and the locate/marking operation, or by cross-trained field staff (e.g., a “dispatch/locate” technician or crew) who is/are capable of performing both the pre-survey activity as well as the locate and marking operation. Thus, whereas conventionally these functions were performed by different technicians during different visits to the work site, pursuant to the methods outlined herein these functions may be performed during a single site visit, in some cases by one or more cross-trained technicians (provided with the appropriate equipment for performing the respective functions performed during the site visit).

In other aspects, methods according to various embodiments discussed herein contemplate different manners (e.g., timing) in which pre-survey activity and a locate and marking operation may be performed as part of pre-installation activity. In one example, pre-survey activity is performed before a locate and marking operation during a single visit to the work site. In other examples, some or all pre-survey activity may be performed after a locate and marking operation, and benefit in some aspect from information obtained from the locate and marking operation. In particular, for situations in which pre-survey activity may include multiple tasks (e.g., white-lining and generation of an engineering plan), some portion of the pre-survey activity (e.g., white-lining) may be performed before a locate and marking operation (e.g., in some instances to facilitate specifying a dig area for purposes of a locate request), whereas another portion of the pre-survey activity (e.g., generation of an engineering plan) may occur after a locate and marking operation (so as to make use of information relating to the presence or absence of pre-existing underground facilities in generating the engineering plan).

In yet other aspects, methods according to various embodiments discussed herein contemplate different manners (e.g., timing, and by whom) in which a locate request to a one-call center is generated (to in turn receive a locate request ticket from the one-call center for a locate and marking operation), so as to improve efficiency in connection with an installation process for an engineered system. For example, in one embodiment, a locate request may be generated to a one-call center (e.g., by either the owner of the engineering system to be installed or an installation contractor) as soon as a work order for an installation process is generated/received, and prior to any visit to the work site. Alternatively, the locate request to the one-call center may be generated by field staff during a visit to the work site (e.g., an initial visit to perform at least pre-survey activity). In either case, the corresponding locate request ticket generated by the one-call center may be received by field staff during a visit to the work site and, pursuant to the ticket, a locate and marking operation may be performed during the same visit to the work site. In this manner, the process of procuring a locate request ticket may be streamlined and in some cases integrated into a single site visit during which both pre-survey activity as well as a locate and marking operation may be performed.

As also noted above, in some embodiments, a “site visit manifest” to provide electronic documentation of an installation of an engineered system (or a portion thereof) may be generated by various field staff visiting the work site, and/or other parties involved with the installation process. For purposes of the present disclosure, the term “site visit manifest” refers to any electronic information that may be generated and/or collected (e.g., by various field staff) in connection with any of multiple possible phases of a given installation of an engineered system at a particular work site. Examples of electronic information constituting at least a portion of a site visit manifest according to various inventive embodiments described herein include, but are not limited to: 1) a digital image of the work site; 2) location information (e.g., geographic coordinates) corresponding to one or more physical survey marks applied to ground, pavement or other surface during pre-survey activity (e.g., “white-lining”); 3) one or more digital representations of physical survey marks overlaid on a digital image of the work site to generate a marked-up digital image of the pre-survey activity; 4) one or more electronic survey marks or dig area indicators overlaid on a digital image of the work site as part of the pre-survey activity to indicate a location/locations at which the installation is planned; 5) an engineering plan for the installation (e.g., digital representations of one or more pieces of equipment to be installed at the work site, overlaid on a digital image of the work site); 6) excavation information relating to one or more types of excavation recommended for disturbing the ground, pavement or other surface to facilitate the installation; 7) locate and marking information generally relating to performance of the locate and marking operation; 8) more specific locate and marking information, such as location information (e.g., geographic coordinates) corresponding to one or more physical locate marks applied to ground, pavement or other surface during a locate and marking operation; 9) one or more digital representations of physical locate marks overlaid on a digital image of the work site to generate a marked-up digital image of the locate and marking operation; and 10) “as-built” information relating to the installation as completed.

In some implementations of a site visit manifest, various information components of the manifest may be configured as independently-accessible and/or independently-viewable information “layers” of the site visit manifest. In one aspect, such information layers may be associated with different levels of permission or access-rights, so that different parties associated with the installation process may selectively view/access all or only some portions of the information constituting the site visit manifest. The various information constituting the site visit manifest may be electronically stored and/or electronically transmitted to various parties associated with the installation process to facilitate one or more of review of the work performed, quality assessment of same, and billing functions. In one implementation, field staff may prepare one portion of the site visit manifest during an initial visit to the work site at which a pre-survey and locate/marking operation are performed (a “preliminary site visit manifest” to electronically document the pre-survey activity and the locate/marking operation), and an excavation/installation crew may prepare another portion of the site visit manifest during a subsequent visit to the work site to perform the installation (in some instances by adding information to the previously-prepared preliminary site visit manifest). Accordingly, during multiple phases of an installation process, a site visit manifest may serve as a “living” electronic document, handed off to different field staff or other parties involved in the installation process, to memorialize various aspects of the installation process and create a useful record of same.

In sum, one embodiment of the present invention is directed to a method of inspecting and/or preparing a work site so as to facilitate an underground utility installation, the method comprising: A) receiving a work order for the underground utility installation, the work order including work site information relating to the work site at which the underground utility installation is requested; B) during a first visit to the work site based on the work order received in A), performing a pre-survey of the work site to indicate where the underground utility installation is planned at the work site; and C) also during the first visit to the work site, performing a locate and marking operation at the work site, wherein the locate and marking operation includes: C1) determining a presence or an absence of at least one previously-installed underground facility at the work site; and C2) applying at least one physical locate mark to ground, pavement, or other surface at the work site so as to indicate the presence or the absence of the at least one previously-installed underground facility.

Another embodiment is directed to a method of generating a site visit manifest so as to facilitate a fiber-to-the-premises (FTTP) installation, the method comprising: A) receiving a work order for the FTTP installation, the work order including work site information relating to a work site at which the FTTP installation is requested; B) during a first visit to the work site based on the work order received in A), performing a pre-survey of the work site to indicate where the FTTP installation is planned at the work site, wherein B) comprises: B1) adding pre-survey information to a digital image of the work site; C) during the first visit to the work site and at the work site, requesting a locate ticket from a one-call center based at least in part on the work site information received in A); D) during the first visit to the work site and at the work site, receiving the locate ticket from the one-call center based at least in part on C); E) during the first visit to the work site, performing a locate and marking operation at the work site pursuant to the locate ticket received in D), wherein the locate and marking operation includes: E1) determining a presence or an absence of at least one previously-installed underground facility at the work site; E2) applying at least one physical locate mark to ground, pavement, or other surface at the work site to indicate the presence or absence of the at least one previously-installed underground facility; and E3) adding to the digital image of the work site at least one electronic locate mark corresponding to the at least one physical locate mark applied in E2); F) during the first visit to the work site and at the work site, closing the locate ticket based on E); and G) electronically transmitting and/or electronically storing a site visit manifest so as to facilitate the FTTP installation, the site visit manifest including the digital image and a plurality of independently-viewable and independently-accessible information layers to be overlaid on the digital image, wherein: a first information layer of the plurality of information layers includes the pre-survey information from B1); and a second information layer of the plurality of information layers includes the at least one electronic locate mark from E3).

Another embodiment is directed to an apparatus for generating a site visit manifest so as to facilitate an underground utility installation, the apparatus comprising: a communication interface; a display device; a user input device; a memory to store processor-executable instructions; and a processor coupled to the communication interface, the display device, the user input device, and the memory, wherein upon execution of the processor-executable instructions by the processor, the processor: A) receives, via at least one of the communication interface and the user input device, a work order for the underground utility installation, the work order including work site information relating to a work site at which the underground utility installation is requested; B) controls the display device to display a digital image of the work site, based at least in part on the work site information received in A); C) receives, via at least one of the communication interface and the user input device, pre-survey information relating to a pre-survey performed at the work site to indicate where the underground utility installation is planned at the work site; D) receives, via at least one of the communication interface and the user input device, locate and marking information relating to performance of a locate and marking operation at the work site, the locate and marking operation including determining a presence or an absence of at least one previously-installed underground facility at the work site and applying at least one physical locate mark to ground, pavement, or other surface at the work site to indicate the presence or the absence of the at least one previously-installed underground facility; E) adds the pre-survey information received in C) and the locate and marking information received in D) to the digital image of the work site displayed in B) so as to generate a site visit manifest; and F) controls at least one of the communication interface and the memory to electronically transmit and/or electronically store information relating to the site visit manifest so as to facilitate the underground utility installation.

Another embodiment is directed to a computer readable storage medium storing processor-executable instructions that, when executed by at least one processor, perform a method for generating a site visit manifest to facilitate an underground utility installation, the method comprising: A) electronically receiving a work order for the underground utility installation, the work order including work site information relating to a work site at which the underground utility installation is requested; B) electronically receiving pre-survey information relating to a pre-survey performed at the work site to indicate where the underground utility installation is planned at the work site; C) electronically receiving locate and marking information relating to performance of a locate and marking operation at the work site, the locate and marking operation including determining a presence or an absence of at least one previously-installed underground facility at the work site and applying at least one physical locate mark to ground, pavement, or other surface at the work site to indicate the presence or the absence of the at least one previously-installed underground facility; D) electronically generating the site visit manifest, wherein the site visit manifest comprises: D1) a digital image of the work site based on the work site information received in A); D2) the pre-survey information received in B); and D3) the locate and marking information received in C); and E) electronically transmitting and/or electronically storing information relating to the site visit manifest generated in D) so as to facilitate the underground utility installation.

Another embodiment is directed to a method of performing an underground utility installation at a work site and generating a site visit manifest for the underground utility installation as completed to provide a searchable electronic record of the underground utility installation, the method comprising: A) electronically receiving a preliminary site visit manifest for the underground utility installation, the preliminary site visit manifest comprising a digital image of the work site and at least one image information layer overlaid on the digital image, the at least one image information layer comprising at least one of: A1) pre-survey information indicating a planned location at the work site for the underground utility installation; and A2) locate and marking information relating to performance of a locate and marking operation at the work site, the locate and marking operation including determining a presence or an absence of at least one previously-installed underground facility at the work site and applying at least one physical locate mark to ground, pavement, or other surface at the work site to indicate the presence or the absence of the at least one previously-installed underground facility; B) performing the underground installation at the work site, based at least in part on the preliminary site visit manifest received in A); C) generating the site visit manifest by electronically updating the preliminary site visit manifest to include at least one additional image information layer to be overlaid on the digital image, the at least one additional image information layer including as-built information relating to the underground utility installation as completed pursuant to B); and D) electronically transmitting and/or electronically storing information relating to the site visit manifest generated in C) so as to provide the searchable electronic record of the underground utility installation.

Another embodiment is directed to a method of performing a fiber-to-the-premises (FTTP) installation at a work site and generating a site visit manifest for the FTTP installation as completed to provide a searchable electronic record of the FTTP installation, the method comprising: A) electronically receiving a work order for the FTTP installation, the work order comprising a preliminary site visit manifest for the FTTP installation, the preliminary site visit manifest comprising a digital image of the work site and a plurality of image information layers overlaid on the digital image, the plurality of image information layers comprising: A1) pre-survey information indicating a planned location at the work site for the FTTP installation; and A2) locate and marking information relating to performance of a locate and marking operation at the work site, the locate and marking operation including determining a presence or an absence of at least one previously-installed underground facility at the work site and applying at least one physical locate mark to ground, pavement, or other surface at the work site to indicate the presence or the absence of the at least one previously-installed underground facility, the locate and marking information including at least one electronic locate mark corresponding to the at least one physical locate mark; B) performing the FTTP installation at the work site, based at least in part on the work order received in A); C) generating the site visit manifest by electronically updating the preliminary site visit manifest to include at least one additional image information layer to be overlaid on the digital image, the at least one additional image information layer including as-built information relating to the FTTP installation as completed pursuant to B); and D) electronically transmitting and/or electronically storing information relating to the site visit manifest generated in C) so as to provide the searchable electronic record of the FTTP installation.

Another embodiment is directed to an apparatus for generating a site visit manifest for an underground utility installation as completed to provide a searchable electronic record of the underground utility installation, the apparatus comprising: a communication interface; a display device; a user input device; a memory to store processor-executable instructions; and a processor coupled to the communication interface, the display device, the user input device, and the memory, wherein upon execution of the processor-executable instructions by the processor, the processor: A) controls the communication interface to receive a preliminary site visit manifest for the underground utility installation, the preliminary site visit manifest comprising a digital image of the work site and at least one image information layer to be overlaid on the digital image, the at least one image information layer comprising at least one of: A1) pre-survey information indicating a planned location at the work site for the underground utility installation; and A2) locate and marking information relating to performance of a locate and marking operation at the work site, the locate and marking operation including determining a presence or an absence of at least one previously-installed underground facility at the work site and applying at least one physical locate mark to ground, pavement, or other surface at the work site to indicate the presence or the absence of the at least one previously-installed underground facility; B) controls the display device to display the preliminary site visit manifest received in A); C) receives, via at least one of the communication interface and the user input device, as-built information relating to the underground utility installation as completed; and D) generates the site visit manifest by electronically updating the preliminary site visit manifest to include at least one additional image information layer to be overlaid on the digital image, the at least one additional image information layer including the as-built information received in C); and E) controls at least one of the communication interface and the memory to electronically transmit and/or electronically store information relating to the site visit manifest generated in D) so as to provide the searchable electronic record of the underground utility installation.

Another embodiment is directed to a computer readable storage medium storing processor-executable instructions that, when executed by at least one processor, perform a method for generating a site visit manifest for an underground utility installation as completed to provide a searchable electronic record of the underground utility installation, the method comprising: A) electronically receiving a preliminary site visit manifest for the underground utility installation, the preliminary site visit manifest comprising a digital image of the work site and at least one image information layer to be overlaid on the digital image, the at least one image information layer comprising at least one of: A1) pre-survey information indicating a planned location at the work site for the underground utility installation; and A2) locate and marking information relating to performance of a locate and marking operation at the work site, the locate and marking operation including determining a presence or an absence of at least one previously-installed underground facility at the work site and applying at least one physical locate mark to ground, pavement, or other surface at the work site to indicate the presence or the absence of the at least one previously-installed underground facility; B) electronically receiving as-built information relating to the underground utility installation as completed; C) electronically generating the site visit manifest by electronically updating the preliminary site visit manifest to include at least one additional image information layer to be overlaid on the digital image, the at least one additional image information layer including the as-built information received in B); and E) electronically transmitting and/or electronically storing information relating to the site visit manifest generated in C) so as to provide the searchable electronic record of the underground utility installation.

For purposes of the present disclosure, the term “dig area” refers to a specified area of a work site within which there is a plan to disturb the ground (e.g., excavate, dig holes and/or trenches, bore, etc.), and beyond which there is no plan to excavate in the immediate surroundings. Thus, the metes and bounds of a dig area are intended to provide specificity as to where some disturbance to the ground is planned at a given work site. It should be appreciated that a given work site may include multiple dig areas.

The term “facility” refers to one or more lines, cables, fibers, conduits, transmitters, receivers, or other physical objects or structures capable of or used for carrying, transmitting, receiving, storing, and providing utilities, energy, data, substances, and/or services, and/or any combination thereof. The term “underground facility” means any facility beneath the surface of the ground. Examples of facilities include, but are not limited to, infrastructure relating to oil, gas, water, sewer, power, telephone, data transmission, cable television (TV), and/or Internet services.

The term “locate device” refers to any apparatus and/or device for detecting and/or inferring the presence or absence of any facility, including without limitation, any underground facility. In various examples, a locate device may include both a locate transmitter and a locate receiver (which in some instances may also be referred to collectively as a “locate instrument set,” or simply “locate set”).

The term “marking device” refers to any apparatus, mechanism, or other device that employs a marking dispenser for causing a marking material and/or marking object to be dispensed, or any apparatus, mechanism, or other device for electronically indicating (e.g., logging in memory) a location, such as a location of an underground facility. Additionally, the term “marking dispenser” refers to any apparatus, mechanism, or other device for dispensing and/or otherwise using, separately or in combination, a marking material and/or a marking object. An example of a marking dispenser may include, but is not limited to, a pressurized can of marking paint. The term “marking material” means any material, substance, compound, and/or element, used or which may be used separately or in combination to mark, signify, and/or indicate. Examples of marking materials may include, but are not limited to, paint, chalk, dye, and/or iron. The term “marking object” means any object and/or objects used or which may be used separately or in combination to mark, signify, and/or indicate. Examples of marking objects may include, but are not limited to, a flag, a dart, and arrow, and/or an RFID marking ball. It is contemplated that marking material may include marking objects. It is further contemplated that the terms “marking materials” or “marking objects” may be used interchangeably in accordance with the present disclosure.

The term “locate mark” means any mark, sign, and/or object employed to indicate the presence or absence of any underground facility. Examples of locate marks may include, but are not limited to, marks made with marking materials, marking objects, global positioning or other information, and/or any other means. Locate marks may be represented in any form including, without limitation, physical, visible, electronic, and/or any combination thereof.

The terms “locate and marking operation,” “locate operation,” and “locate” generally are used interchangeably and refer to any activity to detect, infer, and/or mark the presence or absence of an underground facility. In some contexts, the term “locate operation” is used to more specifically refer to detection of one or more underground facilities, and the term “marking operation” is used to more specifically refer to using a marking material and/or one or more marking objects to mark a presence or an absence of one or more underground facilities. The term “locate technician” refers to an individual performing a locate operation. A locate and marking operation often is specified in connection with a dig area, at least a portion of which may be excavated or otherwise disturbed during excavation activities.

The term “user” refers to an individual utilizing a locate device and/or a marking device and may include, but is not limited to, land surveyors, locate technicians, and support personnel.

The terms “locate request” and “excavation notice” are used interchangeably to refer to any communication to request a locate and marking operation. The term “locate request ticket” (or simply “ticket”) refers to any communication or instruction to perform a locate operation. A ticket might specify, for example, the address or description of a dig area to be marked, the day and/or time that the dig area is to be marked, and/or whether the user is to mark the excavation area for certain gas, water, sewer, power, telephone, cable television, and/or some other underground facility. The term “historical ticket” refers to past tickets that have been completed.

The following U.S. published applications are hereby incorporated herein by reference:

U.S. Publication No. 2009-0238417, published Sep. 24, 2009, corresponding to U.S. non-provisional application Ser. No. 12/366,853, filed on Feb. 6, 2009, entitled “Virtual White Lines for Indicating Planned Excavation Sites on Electronic Images;”

U.S. Publication No. 2009-0327024, published Dec. 31, 2009, corresponding to U.S. non-provisional application Ser. No. 12/493,109, filed on Jun. 26, 2009, entitled “Methods and Apparatus for Quality Assessment of a Field Service Operation;”

U.S. Publication No. 2010-0117654, published May 13, 2010, corresponding to U.S. non-provisional application Ser. No. 12/649,535, filed on Dec. 30, 2009, entitled “Methods and Apparatus for Displaying an Electronic Rendering of a Locate and/or Marking Operation Using Display Layers;”

U.S. Publication No. 2010-0205264, published Aug. 12, 2010, corresponding to U.S. non-provisional application Ser. No. 12/703,313, filed on Feb. 10, 2010, entitled “Methods, Apparatus and Systems for Exchanging Information Between Excavators and Other Entities Associated with Underground Facility Locate and Marking Operations;”

U.S. Publication No. 2010-0189887, published Jul. 29, 2010, corresponding to U.S. non-provisional application Ser. No. 12/703,958, filed on Feb. 11, 2010, entitled “Marking Apparatus Having Enhanced Features for Underground Facility Marking Operations, and Associated Methods and Systems;”

U.S. Publication No. 2011-0007076, published Jan. 13, 2011, corresponding to U.S. non-provisional application Ser. No. 12/831,330, filed on Jul. 7, 2010, entitled “Methods, Apparatus and Systems for Generating Searchable Electronic Records of Underground Facility Locate and/or Marking Operations;” and

U.S. Publication No. 2012-0065944, published Mar. 15, 2012, corresponding to U.S. non-provisional application Ser. No. 13/208,191, filed on Aug. 11, 2011, entitled “Methods, Apparatus and Systems for Facilitating Generation and Assessment of Engineering Plans.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a diagram of a generalized system architecture for an FTTP system.

FIG. 2 illustrates various parties that may be involved in the installation of an engineered system or a portion thereof, in accordance with embodiments of the present invention.

FIG. 3 is a flow diagram illustrating an exemplary method according to one embodiment of the present invention for conducting pre-installation activity relating to an installation of an engineered system.

FIG. 4 illustrates an exemplary work order, in response to which the pre-installation activity in the method of FIG. 3 may be conducted.

FIG. 5 is a flow diagram illustrating an exemplary method according to another embodiment of the present invention for conducting pre-installation activity relating to an installation of an engineered system.

FIG. 6 illustrates a block diagram of an exemplary computing device that may be used in accordance with embodiments of the present invention in connection with pre-installation and/or installation activity associated with installation of an engineered system.

FIG. 7 illustrates an exemplary electronic engineering plan for a work site that may be generated using the computing device of FIG. 6 during the pre-installation activity conducted in the methods of FIG. 3 or FIG. 5, in accordance with embodiments of the present invention.

FIGS. 8 and 9 illustrate various electronic marks and icons that may be used in marking up a digital image of a work site to generate a site visit manifest in accordance with embodiments of the present invention.

FIG. 10 illustrates an electronic site visit manifest showing a work site and various information determined during pre-installation activities and installation activities relating to an engineered system in accordance with embodiments of the present invention.

FIG. 11 is a flow diagram illustrating an exemplary method according to one embodiment of the present invention for conducting installation activity relating to an installation of an engineered system.

FIG. 12 illustrates a method for processing work orders and generating site visit manifests of work performed pursuant to work orders in accordance with embodiments of the present invention.

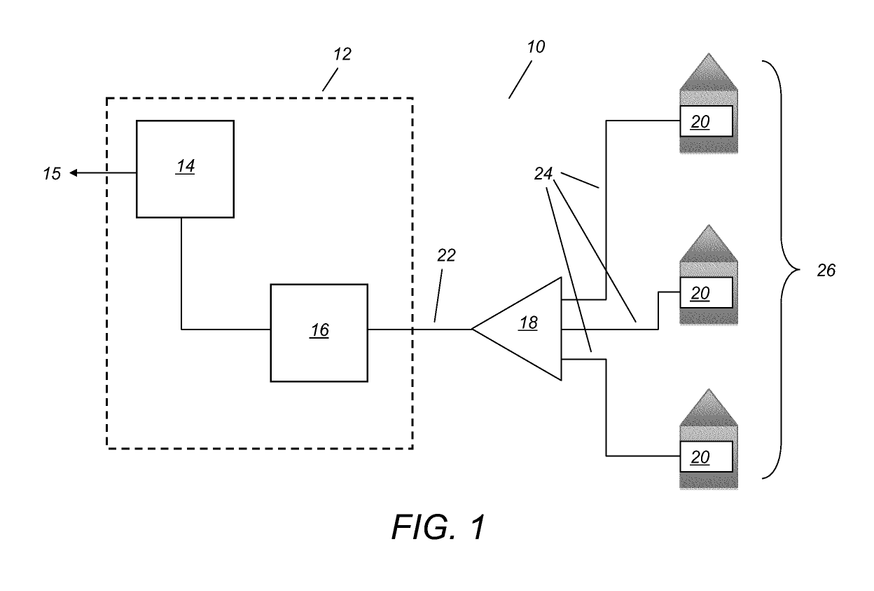

### DETAILED DESCRIPTION

Following below are more detailed descriptions of various concepts related to, and embodiments of, inventive systems, methods and apparatus for performing utility installations and generating site visit manifests for installations of engineered systems. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Overview

As noted above, in conventional approaches for installing an engineered system or a portion thereof, typically a series of field operations requiring multiple visits to a work site are performed by various field staff (engineers, technicians, construction/installation crews, etc.). Such conventional approaches may involve undue delay and/or inefficient use of resources during the installation process. Accordingly, improved methods, apparatus and systems for performing installations of engineered systems are presented below. In one aspect, examples of improved methods described herein involve some degree of consolidation of the number of site visits to a work site of a planned installation, and/or consolidation of particular work performed in a given site visit, so as to improve the efficiency and/or other aspects of the installation process. In other aspects, different manners (e.g., timing, and by whom) in which a locate request to a one-call center is generated (to in turn receive a locate request ticket from the one-call center for a locate and marking operation) are contemplated so as to improve efficiency in connection with an installation process for an engineered system.

In yet another aspect of various embodiments, a “site visit manifest” is generated to provide electronic documentation of pre-installation activity and/or installation activity for an engineered system. Various types of electronic information may be generated and/or collected (e.g., by various field staff) in connection with any of multiple possible phases of a given installation of an engineered system at a particular work site for purposes of generating a site visit manifest. Additionally, different information components of a site visit manifest may be selectively viewed/accessed (e.g., based on different levels of permission or access-rights), to facilitate one or more of review of the work performed, quality assessment of same, and billing functions.

While many of the concepts disclosed herein may be particularly germane to improving an installation process for engineered systems such as underground facilities, it should be appreciated that the inventive embodiments described herein are not limited in this respect, and may apply similarly to above-ground installations of at least some portion of an engineered system. Also, while some embodiments described herein are directed to Fiber to the Premises (FTTP) installations (e.g., installation of new FTTP services involving a new drop to a subscriber premises, or “subscriber drop”), it should be appreciated that the inventive embodiments disclosed herein are not limited in this respect, and may apply similarly to installations of other types of underground facilities and, more generally, other types of engineered systems.

Pre-Installation Activities

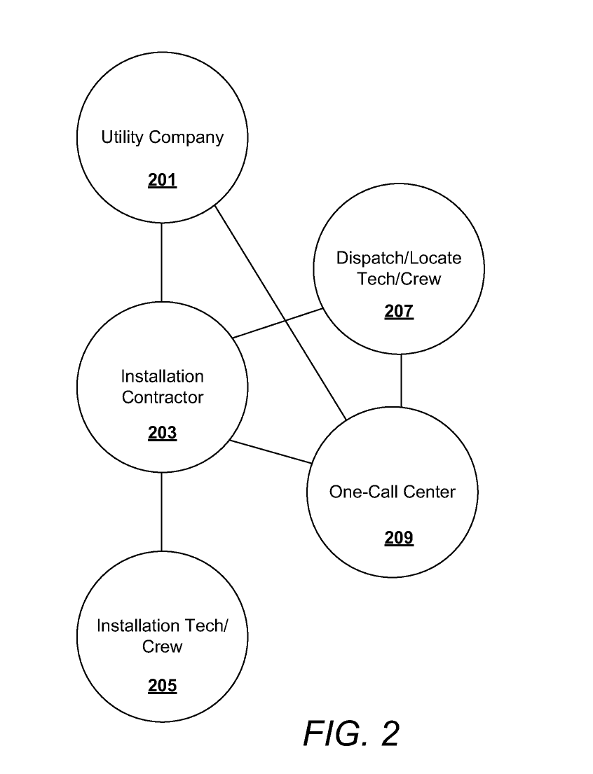

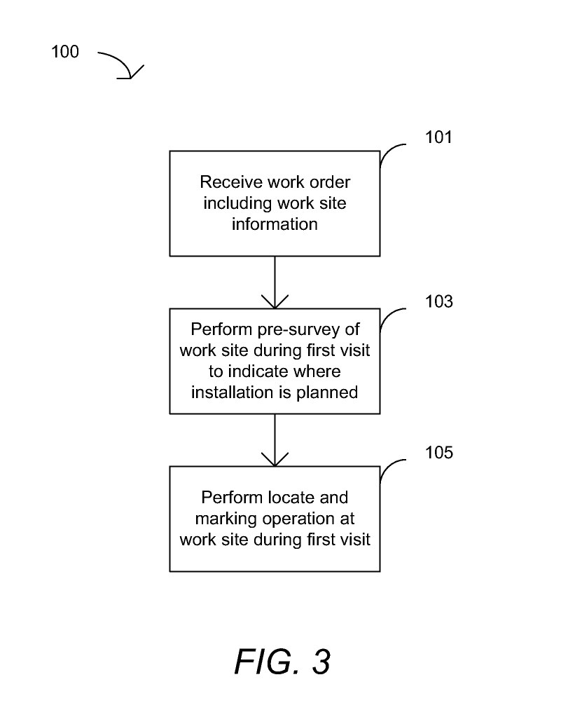

An exemplary process relating to pre-installation activity according to one embodiment of the present invention will now be described with reference to FIGS. 2 and 3; FIG. 2 provides an overview of the various parties (and their associated information-handling systems, such as computing devices and data storage devices) that may be involved in some capacity in connection with installation of an engineered system, and FIG. 3 provides an overview of a method in which pre-installation activity may be conducted at a work site of a planned installation (e.g., a method of inspecting and/or preparing a work site so as to facilitate an underground utility installation).

As shown in FIG. 2, a utility company 201 typically commissions an installation project to an installation contractor 203. The installation contractor 203 is responsible for various pre-installation activity, which may include “pre-survey” activity as well as a locate and marking operation, as discussed above. The installation contractor 203 also is ultimately responsible for actual installation of the engineered system or a portion thereof. To these ends, according to one embodiment, the installation contractor 203 arranges for various field staff to be sent to the work site of a planned installation. In particular, the installation contractor 203 first commissions a dispatch/locate technician or crew 207 (a crew also may be referred to herein as a “field team”) to attend to the pre-installation activity (e.g., the pre-survey activity and the locate and marking operation). In one embodiment discussed below in connection with FIG. 3, both the pre-survey activity as well as the locate and marking operation may be performed during a single visit to a work site. In one aspect, the pre-survey activity and the locate and marking operation may be performed by tandem members of a dispatch/locate crew or field team respectively responsible for the pre-survey activity and the locate and marking operation; alternatively, both the pre-survey activity and the locate and marking operation may be performed by a single cross-trained dispatch/locate technician or cross-trained field team capable of performing both the pre-survey activity as well as the locate and marking operation (and provided with the appropriate equipment for performing the respective functions of the pre-survey activity and the locate and marking operation).

As also noted above, the locate and marking operation is performed pursuant to a locate request ticket issued by a one-call center 209. In various examples, the utility company 201, the installation contractor 203 or the dispatch/locate technician or crew 207 may initially notify the one-call center 209 of a planned installation at a particular work site; based on such a notification (a “locate request”), the one-call center 209 issues the locate request ticket for performance of the locate and marking operation.

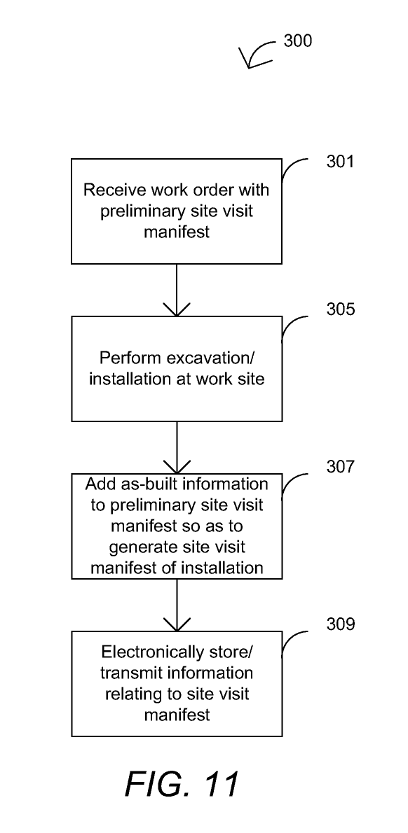

As also shown in FIG. 2, subsequent to the pre-installation activity, the installation contractor 203 commissions an installation technician or crew 205 to attend to the installation of the engineered system or a portion thereof. In some implementations, the installation technician/crew 205 also is responsible for any excavation that may be attendant to the installation process involving an underground utility (e.g., a buried FTTP subscriber drop). Additional details relating to installation activity by an installation technician or crew 205 are discussed further below in connection with FIG. 11.

FIG. 3 illustrates a method 100 for performing pre-installation activity at a work site (e.g., a method of inspecting and/or preparing a work site so as to facilitate an underground utility installation) according to one embodiment of the present invention. As noted above, in one example, the method 100 provides for performance of both pre-survey activity (e.g., block 103) and a locate and marking operation (e.g., block 105) during a single visit to a work site identified in a work order so as to improve the efficiency of pre-installation activity.

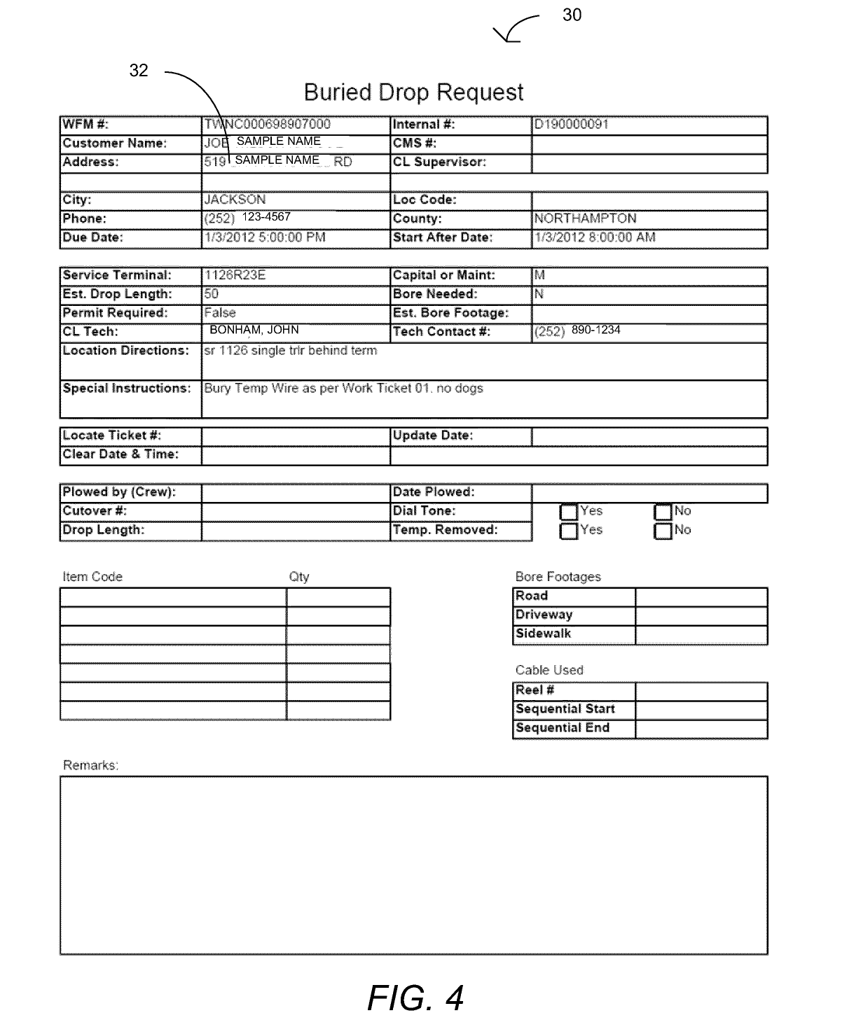

More specifically, the method 100 shown in FIG. 3 begins at block 101 with the receipt of a work order by the installation contractor 203. In one example, the work order is issued by the utility company 201 to the installation contractor 203 following receipt by the utility company of a request for installation of an engineered system or a portion thereof (e.g., a request by a prospective subscriber for FTTP services at the subscriber's premises). As noted above, the work order may have a variety of content and formats, and may be in the form of an email or other electronic message sent to the installation contractor 203. In general, the work order typically includes text information describing a work site (e.g., geographic information indicating a location of the work site, and a description specifying the extent/metes and bounds of the work site). Examples of geographic information relating to the work site that may be provided in a work order include, but are not limited to, alphanumeric information designating a street address, street intersection, geographic region or other map information (e.g., designating one or more particular map grids or grid coordinates of one or more facilities maps), as well as one or more GPS latitude/longitude coordinate pairs representing a location and/or extent of the work site. The work order may include other information regarding work scope (particulars regarding equipment and/or type of infrastructure/utility to be installed and/or results to be achieved), duration (amount of time estimated to be needed to complete the plan), and cost estimates. A non-limiting example of a work order 30 for an FTTP installation (i.e., installation of an FTTP buried subscriber drop), including work site information 32 (e.g., a customer address, city, and county for the planned subscriber drop), is given in FIG. 4.

Pursuant to a work order, the installation contractor 203 commissions the dispatch/locate technician or crew 207 to attend to various pre-installation activity, including both pre-survey activity and a locate and marking operation during a single visit to the work site. In particular, as shown in FIG. 3, in block 103 the dispatch/locate technician or crew 207 performs a pre-survey of the work site to indicate where the installation is planned at the work site. As discussed above, one type of pre-survey activity that may be performed in block 103 is sometimes referred to as a “dispatch,” during which field staff generally assess the work site to determine where underground utility infrastructure should be installed, and get a sense of the general work effort involved in the installation. During such a “dispatch,” field staff may observe terrain and landscaping conditions, a presence of one or more natural or manmade environmental landmarks (e.g., trees, boulders, utility poles, paved surfaces, curbs, etc.), existing above-ground structures and/or connection points to pre-existing underground infrastructure to which the new utility being installed is to be coupled, and the like. In some instances, a dispatch also may include “white-lining,” in which field staff mark (on ground, pavement or other surface at the work site) where excavation (some type of disturbance of the ground, e.g., digging, trenching, boring) is required as part of the installation. This process is referred to as “white-lining,” as the field staff typically employ white paint and/or white flags as one or more physical survey marks placed on the ground, pavement or other surface to indicate one or more locations at which underground facility installation is planned.

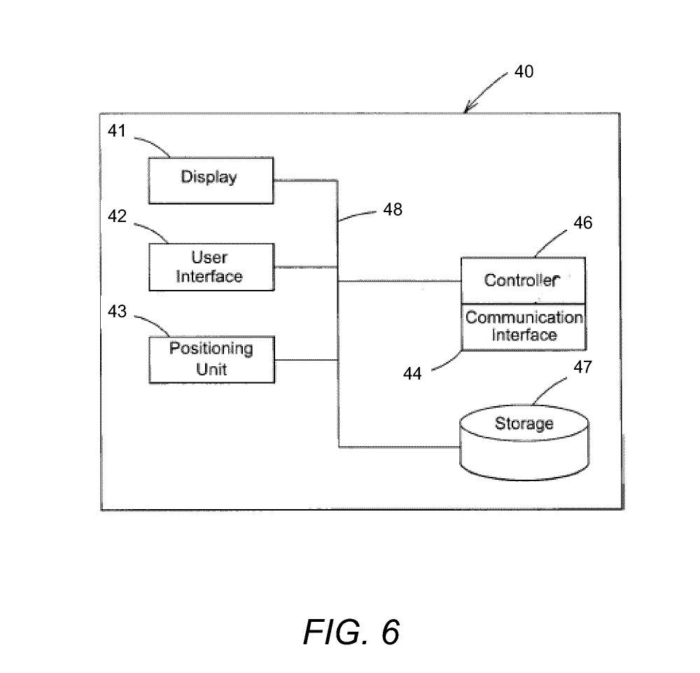

Other types of pre-survey activity that may be performed in block 103 may involve some type of electronic documentation of information via a personal and/or portable computing device used by the dispatch/locate technician or crew 207 (e.g., a mobile telecommunications device or a tablet computer). For example, the dispatch/locate technician may utilize a computing device to electronically document the process of physical white-lining (e.g., marking-up a digital image of the work site with a digital representation corresponding to one or more physical survey marks applied to ground, pavement or other surface at the work site to indicate the planned location for the underground utility installation); alternatively, rather than placing physical survey marks on the ground, the dispatch/locate technician or crew 207 may use the computing device to mark-up a digital image of the work site with one or more electronic survey marks to indicate the planned location for the underground utility installation. The dispatch/locate technician or crew 207 also may use the computing device to record excavation information relating to one or more types of excavation recommended for disturbing the ground, pavement or other surface to facilitate the underground utility installation, and/or generate an engineering plan for the underground utility installation. Various pre-survey activity involving use of a computing device is discussed in greater detail below in connection with FIG. 6.

In block 105 of the method 100 illustrated in FIG. 3, the dispatch/locate technician or crew 107 performs a locate and marking operation at the work site to identify underground utilities. As noted above, a locate and marking operation generally includes determining a presence or an absence of one or more previously-installed underground facilities at the work site, and applying one or more physical locate marks to ground, pavement, or other surface at the work site so as to indicate the presence or the absence of the previously-installed underground facility/facilities.

In one aspect of the method 100 shown in FIG. 3, the locate and marking operation and the pre-survey are performed during the same visit to the work site so as to improve efficiency and significantly reduce time associated with pre-installation activity. To this end, the pre-survey activity and the locate and marking operation may be performed by tandem members of a dispatch/locate crew or field team 207 respectively responsible for the pre-survey activity and the locate and marking operation; alternatively, both the pre-survey activity and the locate and marking operation may be performed by a single cross-trained dispatch/locate technician or cross-trained field team capable of performing both the pre-survey activity as well as the locate and marking operation. In any case, performance of the pre-survey and the locate and marking operation during a single visit to the work site pursuant to the method 100 of FIG. 3 obviates the need to send multiple crews in multiple vehicles on multiple visits to the work site (thereby saving time and money).

In another aspect of the method 100 shown in FIG. 3, it should be appreciated that in various implementations, blocks 103 (pre-survey activity) and 105 (locate and marking operation) need not necessarily be performed in any particular order. For example, in one implementation, pre-survey activity is performed before a locate and marking operation during a single visit to the work site. In other examples, some or all pre-survey activity may be performed after a locate and marking operation, and benefit in some respect from information obtained from the locate and marking operation. In particular, for situations in which pre-survey activity may include multiple tasks (e.g., white-lining and generation of an engineering plan), some portion of the pre-survey activity (e.g., white-lining) may be performed before a locate and marking operation (e.g., in some instances to facilitate specifying a dig area for purposes of a locate request), whereas another portion of the pre-survey activity (e.g., generation of an engineering plan) may occur after a locate and marking operation (so as to make use of information relating to the presence or absence of pre-existing underground facilities in generating the engineering plan).

As noted above, and with reference again to FIG. 2, a locate and marking operation typically is performed pursuant to a locate request ticket issued by a one-call center 209. The one-call center 209 issues such a ticket in response to an excavation notification or a “locate request,” which may be submitted to the one-call center (e.g., via phone or web-based electronic access) by any of a number of parties associated with planned activity involving possible excavation. For example, in various embodiments according to the present invention, any one of the utility company 201, the installation contractor 203, or a dispatch/locate technician or crew 207 may submit a locate request to the one-call center 209, pursuant to which request the one-call center issues a locate request ticket (which may be transmitted by the one-call center via email or other electronic and/or wireless communication methodology). While not explicitly shown in FIG. 2, it should be appreciated that various information relating to the locate request and/or the locate request ticket (e.g., identification of the requesting party, time of request, date of planned excavation activity, various information identifying the work site, a corresponding work order identification, a ticket number, etc.) may be stored in a database at the one-call center, and/or may be transmitted and stored in a centralized database and made accessible to various parties (e.g., the utility owner 201, the installation contractor 203, other parties implicated by the planned excavation activity).

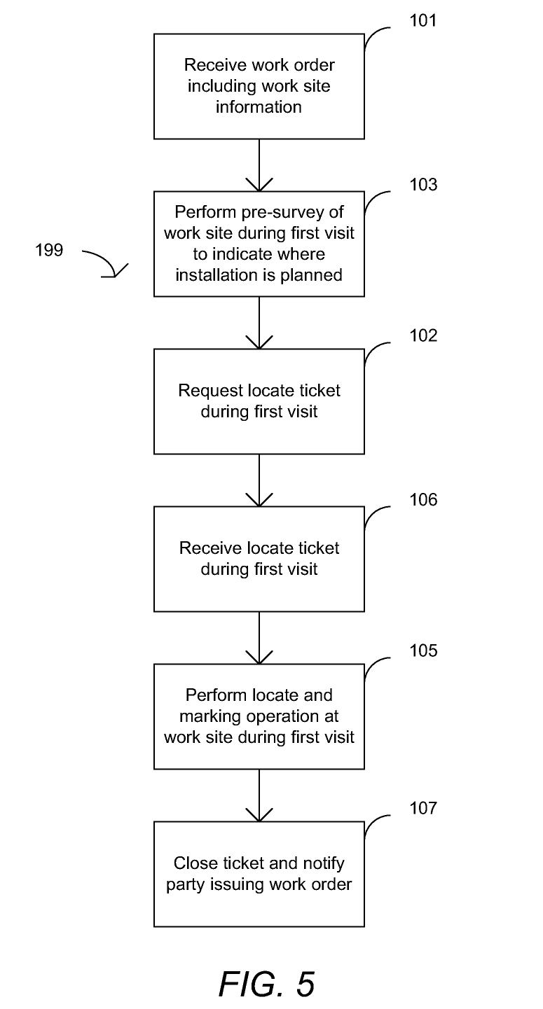

In one embodiment, the method 100 of FIG. 3 may be modified to specify particular circumstances for requesting and receiving locate tickets so as to improve an efficiency of pre-installation activities. In particular, FIG. 5 illustrates a method 199, based on the method 100 of FIG. 3, in which additional blocks 102, 106 and 107 are included to specify requesting, receiving, and closing a locate ticket during a same visit to the work site in which a pre-survey (block 103) and a locate and marking operation (block 105) are performed. In one exemplary implementation of the method 199 of FIG. 5, the dispatch/locate technician or crew 207 proceeds to the work site according to the work site information in a work order. Once at the work site, the dispatch/locate technician or crew 207 notifies the one-call center 209 of the planned installation and receives the locate request ticket from the one-call center 209. As discussed further below in connection with FIG. 6, the dispatch/locate technician or crew may use a personal and/or portable computing device (e.g., a mobile telecommunications device or tablet computer) to electronically and/or wirelessly receive the work order, submit the locate request to the one-call center, and receive back from the one-call center the locate request ticket. The dispatch/locate technician or crew 207 performs a locate and marking operation pursuant to the received ticket, and closes the ticket all during the same visit to the work site, thereby significantly reducing the time involved in requesting and performing the locate and marking operation.

As noted above in connection with FIG. 3, it should be appreciated that in various implementations, blocks 103 (pre-survey activity) and 105 (locate and marking operation) of the method 199 shown in FIG. 5 need not necessarily be performed in any particular order with respect to each other; in particular, in some implementations of the method 199 of FIG. 5, portion or all of the pre-survey activity may be performed after the locate and marking operation.

As also shown in FIG. 5, in block 107, upon completing the locate and marking operation and closing the ticket (e.g., with the one-call center 209), the party issuing the work order (e.g., the utility owner 201 or the installation contractor 203) may be notified that the locate and marking operation (and in some instances all of the pre-installation activity including the pre-survey) is complete. This process of notifying the party issuing the work order when various aspects of work are completed at the work site is sometimes referred to as “positive response.” In connection with positive response notification, the dispatch/locate technician or crew 207 may send an electronic communication (e.g., via a computing device, discussed further below in connection with FIG. 6) to the party issuing the work order (or make available an electronic document/communication that may be queried/retrieved periodically by the party issuing the work order). The electronic communication/documentation constituting a positive response notification may be a simple text-based message, or alternatively may include any of a variety of information relating to the pre-installation activity (including information relating to electronic documentation generated during the pre-installation activity, as discussed further below in connection with “site visit manifests”). Various concepts relating generally to positive response notifications in the context of locate and marking operations, some of which concepts may be applicable to the methods disclosed herein, are discussed in detail in U.S. Publication No. 2010-0205264, published Aug. 12, 2010, corresponding to U.S. non-provisional application Ser. No. 12/703,313, filed on Feb. 10, 2010, entitled “Methods, Apparatus and Systems for Exchanging Information Between Excavators and Other Entities Associated with Underground Facility Locate and Marking Operations,” which publication is incorporated by reference herein in its entirety.

In one aspect of the method 199 shown in FIG. 5, the dispatch/locate technician or crew 207 may submit a locate request to the one-call center 209 from the work site after completion of the pre-survey, in which case the dispatch/locate technician or crew may have more information available to provide in the locate request. For example, the locate request may be made based on a preliminary inspection of the work site to determine where the installation may or may not necessitate excavation. In some instances, such an inspection pursuant to a pre-survey may reduce the total geographic area at/within the work site for which a locate and marking operation is to be performed pursuant to the locate ticket, thereby potentially saving time and money (e.g., the dispatch/locate technician or crew 207 may determine that the installation will be confined to the front yard of a property indicated in a work order, and thus the back yard need not be part of the locate and marking operation and the submitted locate request would only specify the front yard as a potential dig area in which excavation is planned).

In another aspect of the method 199 shown in FIG. 5, the dispatch/locate technician or crew 207 may use a personal and/or portable computing device (discussed further below in connection with FIG. 6) to submit a locate request to the one-call center 209 in the form of a marked-up digital image of the work site including one or more dig indicators added to the digital image to precisely identify where in the work site excavation is planned to facilitate the installation of an engineered system. Exemplary methods, apparatus and systems for facilitating generation of such marked-up digital images including one or more dig area indicators are described in detail in U.S. Publication No. 2009-0238417, published Sep. 24, 2009, corresponding to U.S. non-provisional application Ser. No. 12/366,853, filed on Feb. 6, 2009, entitled “Virtual White Lines for Indicating Planned Excavation Sites on Electronic Images,” which publication is hereby incorporated by reference in its entirety. Such a marked-up digital image may be created at the work site or prior to arriving at the work site and electronically transmitted to the one-call center 209 (and also may be sent to and stored in a centralized database accessible to various parties associated with the planned excavation/installation).

In connection with both the method 100 of FIG. 3 and the method 199 of FIG. 5, in some embodiments the dispatch/locate technician or crew 207 may employ one or more processor-based marking devices during one or both of a pre-survey or a locate and marking operation to apply physical survey marks and/or physical locate marks to ground, pavement or other surface at the work site. Such a processor-based marking device may record geographic coordinates (e.g., GPS latitude/longitude coordinates) corresponding to geographic locations at which physical survey marks and/or physical locate marks are applied to ground, pavement, or other surface. The geographic coordinates may then be electronically stored in memory and/or transmitted from the marking device to another computing device (e.g., a personal/portable computing device used by the dispatch/locate technician or crew 207 or other computing device), and/or may be used to mark-up a digital image representing the work site (e.g., to overlay on the digital image one or more electronic survey marks and/or one or more electronic locate marks). Exemplary processor-based marking devices are described in detail in U.S. Publication No. 2010-0189887, published Jul. 29, 2010, corresponding to U.S. non-provisional application Ser. No. 12/703,958, filed on Feb. 11, 2010, entitled “Marking Apparatus Having Enhanced Features for Underground Facility Marking Operations, and Associated Methods and Systems,” which publication is hereby incorporated by reference in its entirety.

Computing Devices to Facilitate Pre-Installation and Installation Activities

As noted above, in some embodiments the dispatch/locate technician or crew 207, and also the installation technician or crew 205, may employ a computing device such as a personal and/or portable computing device (e.g., a mobile telecommunications device or tablet computer) in connection with various pre-installation and/or installation activities. FIG. 6 illustrates a block diagram of an exemplary computing device 40 that may be used in accordance with embodiments of the present invention in connection with pre-installation and/or installation activity associated with installation of an engineered system.

In one implementation, the computing device 40 may be a mobile and/or hand-held device with a form factor that is similar to a tablet computer, laptop computer, or other similar device having a display screen and a user interface that permits a user to interact with the device 40 regarding an image presented on the display. Thus, the computing device 40 comprises a display device 41, such as a liquid crystal display (LCD), an electrophoretic display, or other device capable of presenting image information to a user. The display device 41 may be light emitting (like many LCD's), and/or may be visible using reflected ambient light. The computing device also comprises one or more user interfaces 42 (also referred to herein as “user input devices”), which may be arranged to receive input from a user as well as provide output to the user, such as by displaying information on the display device 41, providing a audible signal (such as synthesized voice) to the user via a speaker, illuminating one or more lights or other visible devices, printing text or graphics onto paper, and so on. The user interface 42 may include a touch screen or similar device that is associated with the display device 41 so that a user can physically interact with the displayed image to provide input to the user interface 42. For example, the user interface 42 may permit a user to draw on a displayed image using a stylus, finger or other object, e.g., to create written text or graphics. The user interface 42 may include other devices to receive user input, including a keyboard, a keypad, a touchpad, a mouse or other pointing device, a voice recognition system, a graphical user interface, a camera, a microphone, a printer, a communications interface, one or more buttons, switches, dials, sliders, and so on. In some embodiments, the user interface 42 may include a device that monitors a condition of the user, such as eye movement, brain activity, or heart rate so as to generate or otherwise receive user input. The condition information may be used to assess the reliability of the user inputs. For example, if the monitored heart rate of the user is sufficiently high as to indicate that the user is under stress, the reliability of the user inputs may be assessed as poor. In short, the user interface 42 may include any suitable hardware, software and/or other components to provide information to a user and receive information from a user.

The computing device 40 may also include a positioning unit 43 that the computing device 40 can use to determine its current location and/or the location of another object at a work site. For example, the positioning unit 43 may include a global positioning system (GPS) unit, a global navigation satellite system (GNSS) receiver, an inertial navigation unit, a WiFi-based positioning system (such as that supported by Skyhook Wireless), a cell phone-based positioning system or other arrangement that uses triangulation and/or known transmitter/receiver location to determine a wireless device's position, a special purpose local positioning system (such as a system that uses radio frequency tags and one or more interrogators that determine tag location based on triangulation, signal time of flight, etc.), and so on. The positioning unit 43 may alternately, or in addition, be arranged to exploit the known position of an existing landmark or other component to determine the tool's location. For example, the positioning unit 43 may have an optical or acoustic rangefinding system that is used to determine a distance from (and/or bearing to) a landmark, such as a fire hydrant or telephone pole, and thus determine the computing device's position. In another embodiment, the positioning system 43 may receive information about the computing device's (or another object's) current position from another device. For example, the computing device 40 may communicate (e.g., wirelessly via Bluetooth) with a GPS-enabled cell phone, a surveying staff, or other device, which relays the device's current position to the computing device 40. The computing device 40 may use this position as its own position, or use the information to determine the computing device's position. In some embodiments, the positioning unit 43 may determine the computing device's location to within about thirty centimeters or less.

Via a bus 48, a controller 46 (e.g., a processor) may communicate with the various components of the computing device 40 and control the operation of the components as well as provide other functions or services, such as wired or wireless communications, electrical power, data processing, image capture (whether still or video), memory management, and so on (the bus 48 may also include a path that permits communication among other components of the computing device 40, provides power to components, or otherwise provides a connection between components of the computing device 40). Thus, the controller 46 may include components such as a programmed computer, a processor, a microprocessor, processing logic or other data processor (or an array of computers or processors), and may further include local computer-readable memory to store software code or other computer-executable instructions for controlling operation of one or more components, communication busses and interfaces, a still and/or video camera, one or more sensors, actuators, relays, switches, a power supply, and/or other suitable components. A communication interface 44 included with the controller 46 may include any transceiver-like mechanism that enables the computing device 40 to communicate with other devices and/or systems. For example, the communication interface may include mechanisms for communicating with another device or system via a network, such as the Internet, a LAN or WLAN, a PAN, and so on.

The computing device 40 may also include non-transient computer-readable storage 47, such as one or more floppy discs, compact discs, optical discs, magnetic tapes, flash memories, random access memory (RAM), a read only memory (ROM), a memory card, a magnetic and/or optical recording medium, circuit configurations in Field Programmable Gate Arrays or other semiconductor devices, or other volatile or non-volatile memories. The computer readable medium or media can be transportable, such that a program or programs stored thereon can be loaded onto one or more different computers or other processors to implement various aspects of the present invention as discussed above. The storage 47 may be used to store any suitable information, such as software code or other instructions used by the controller 46 or other components of the computing device 40, image data used to display an image of a work site, work orders, site visit manifests in various stages of completion, and so on.

As discussed above, the computing device 40 may be used by a dispatch/locate technician or crew 207 in connection with various pre-installation activities. Regarding pre-survey activities, the computing device 40 may be used to electronically document the process of physical white-lining (e.g., marking-up a digital image of the work site with a digital representation corresponding to one or more physical survey marks applied to ground, pavement or other surface at the work site to indicate the planned location for the underground utility installation); alternatively, rather than placing physical survey marks on the ground, the dispatch/locate technician or crew 207 may use the computing device to mark-up a digital image of the work site with one or more electronic survey marks to indicate the planned location for the underground utility installation. The dispatch/locate technician or crew 207 also may use the computing device to record excavation information relating to a type of excavation recommended for disturbing the ground, pavement or other surface to facilitate the underground utility installation, and/or generate an engineering plan for the underground utility installation.

Regarding locate and marking operations, the computing device 40 may be used by a dispatch/locate technician or crew 207 to receive work orders, submit locate requests to a one-call center (including image-based locate requests in which a digital image of the work site is marked-up with one or more dig area indicators), and receive locate request tickets from the one-call center. As discussed further below (in connection with “site visit manifests”), the computing device 40 also may be used to provide an electronic record of the locate and marking operation performed at the work site; exemplary concepts relating to the electronic records of locate and marking operations are discussed in detail in U.S. Publication No. 2011-0007076, published Jan. 13, 2011, corresponding to U.S. non-provisional application Ser. No. 12/831,330, filed on Jul. 7, 2010, entitled “Methods, Apparatus and Systems for Generating Searchable Electronic Records of Underground Facility Locate and/or Marking Operations,” which publication is hereby incorporated herein by reference.

Engineering Plans

As noted above, one type of pre-survey activity that may be performed by the dispatch/locate technician or crew 207 (e.g., in block 103 of the method 100 of FIG. 3 or the method 199 of FIG. 5) may involve the generation of an “engineering plan” to specify the design of an engineered system to be installed. The installation of engineered systems at a work site in some instances may require the preparation of an engineering plan that the installation technician/crew 205 may use to identify and/or place (install) various system components at the work site. For example, in connection with installation of telecommunication systems or portions thereof, an installation technician/crew 205 may use an engineering plan to identify where junction boxes, conduit, switches and other components are to be placed at a work site, perform necessary excavation or other preparation at the various equipment locations, and install the equipment appropriately. Exemplary concepts relating to engineering plans are described in detail in U.S. Publication No. 2012-0065944, published Mar. 15, 2012, corresponding to U.S. non-provisional application Ser. No. 13/208,191, filed on Aug. 11, 2011, entitled “Methods, Apparatus and Systems for Facilitating Generation and Assessment of Engineering Plans,” which publication is hereby incorporated by reference in its entirety.

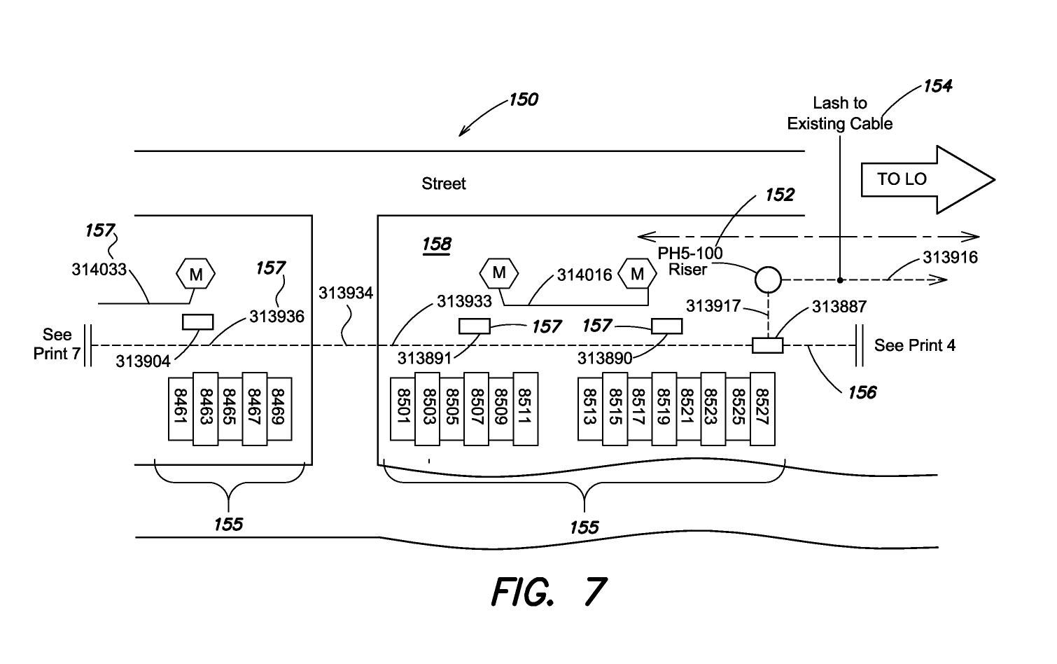

An example of an electronic engineering plan generated for a work site is now described with reference to FIG. 7. Electronic engineering plans generated in accordance with various embodiments of the present invention may include one or both of graphic and text components that describe how, and what type of, equipment relating to an engineered system is to be installed at a work site (and in some instances other work that is to be done at the work site). FIG. 7 shows an illustrative image of an engineering plan 150 that may be generated electronically according to various embodiments of the present invention. It should be appreciated that aspects of the invention should not necessarily be limited to the type, arrangement or other aspects of the plan 150 shown in FIG. 7. Rather, FIG. 7 is only intended to be illustrative; in particular, although the engineering plan 150 of FIG. 7 relates to installation of a fiber optic telecommunication system for a multiple-dwelling unit complex, an engineering plan generated in accordance with the inventive concepts discussed herein may relate to other types of engineered systems.

The example engineering plan 150 of FIG. 7 depicts an illustrative fiber optic cable installation 156 to be made at a work site 158 that includes several condominium units 155. The engineering plan 150 substantially comprises a marked-up digital image of a work site, wherein the marked-up image includes various details relating to installation of equipment constituting fiber optic cable infrastructure, as well as existing structural/environmental features at the work site (sometimes referred to as “landmarks”). For example, the engineering plan 150 includes an identification number 152 for an existing utility pole (i.e., pole number PH5-100 in the upper right of the image), instructions 154 for installation of fiber optic cable (e.g., that the new fiber optic cable is to be lashed to an existing cable hung from pole number PH5-100), and the locations at which various pieces of equipment 157 are to be installed at the work site. In this illustrative embodiment, pieces of equipment 157 or equipment portions are identified by a six digit number, such as “313916.” For this particular plan, the six digit number can be cross-referenced against a textual listing (not shown) that identifies important information for the equipment, such as the size, shape, material, functional capabilities, installation details, and so on, for a corresponding piece of equipment. For example, the junction box identified by “313887” in this plan may have a size of 36 inches by 36 inches and be arranged to house a suitable hub for accommodating the cable feeds extending from the box. This information may be provided in a separate printed paper listing, or computerized display that complements the plan drawing of FIG. 7. In exemplary implementations, locations at which equipment is to be installed may be represented by dimension lines, geographic coordinates, vector coordinates, distances from one or more landmarks (such as an existing electrical transformer platform and sewer manhole), and others. The plan may also be prepared so as to be to scale, or not, as desired.

The electronic engineering plan 150 shown in FIG. 7 may employ any suitable format for the electronic information underlying the plan, such as commonly used computer aided drafting (CAD) formats, bitmap or other image formats. Portions of a plan in electronic format may be linked to other data sources so that a dispatch/locate technician can more easily access desired information. For example, the plan 150 of FIG. 7 may be viewed on a computer screen and arranged so that if the dispatch/locate technician moves a cursor over one of the six digit codes representing a piece of equipment 157, details regarding the corresponding equipment, such as its size, shape, cost and/or other characteristics, may be displayed (e.g., overlaid or superimposed, or illustrated in a dedicated window) on the image. Such selection of a number code or other feature on a plan drawing may also cause other information to be displayed, such as another drawing that shows details regarding the orientation, depth in the ground, distance of the equipment from one or more landmarks, or other arrangement for the equipment when installed, for example. Of course, such information may be provided in more conventional ways, such as listing the information on the plan itself, and/or on supplemental drawing sheets.

To prepare an engineering plan 150 like that shown in FIG. 7, according to one embodiment, the dispatch/locate technician or crew 207 may visit the work site and utilize a plan generating tool (e.g., a particularly-programmed portable computing device including one or more processors, storage devices, communication interfaces, display devices, input/output ports, user interfaces, etc., as discussed above in connection with FIG. 6). In general, using such a plan generating tool at the work site, the dispatch/locate technician or crew 207 may have displayed to them one or more digital images of the work site (referred to herein as “work site base image(s)”) that are representative of the work site. Using various drawing and annotation resources provided by the plan generating tool (and in some cases accessed via one or more user interfaces/user input devices associated with the plan generating tool), the dispatch/locate technician or crew 207 marks-up the work site base image, while at the work site, to indicate various components (pieces of equipment) of infrastructure to be installed. For example, the work site base image may be displayed on a touch-type computer display screen of the plan generating tool that allows the dispatch/locate technician or crew 207 to make handwritten notes and graphics on the base image, to select and place on the displayed image one or more icons or other symbols representing equipment to be installed, to indicate the location of pre-existing utilities or landmarks, and so on.

The work site base image(s) that are marked-up by the dispatch/locate technician or crew 207 to generate the engineering plan may be any of a variety of image types and/or be provided in any suitable way (e.g., facilities maps, street maps, architectural drawings, photographs, aerial/satellite images, etc.). For example, in some instances, a base image may be provided as a scanned hand drawing (e.g., an engineer may hand sketch an image of a work site including landmarks such as buildings, trees, existing utility poles, etc.), a scanned image of a printed plat of the work site, a CAD drawing of the work site, an aerial or other camera image of the work site, and so on. The image(s) may include any suitable information, examples of which include but are not limited to, one or more buildings, natural or man-made landmarks, property boundaries, streets/intersections, public works or facilities such as existing street lighting, signage, fire hydrants, mail boxes, parking meters, and underground facilities (e.g., gas lines, power lines, telephone, cable, fiber optics, water, sewer, drainage). Such images may present some or all information to scale, or may not be to scale with respect to any features. Also, different pieces of image information can be combined (e.g., overlaid or superimposed) to provide a composite image serving as a work site base image. For example, an aerial image of a work site may be overlaid with a utility plat (facilities map) so that the work site base image may indicate existing landmarks such as trees and buildings, as well as existing utility infrastructure, such as water lines, gas lines, electric lines, and so on.

Generating the engineering plan may include marking up the digital image by adding a digital representation of one or more pieces of equipment to the digital image, indicating the location at which the equipment is to be installed. For example, various icons may be added, including, but not limited to, icons representing junction boxes, standard conduits, placements under roadways, and utility poles.

The information in the engineering plan also may be used to generate further information such as a list of equipment that the installation technician or crew 205 is expected to need for the installation, including tools for use in the installation and/or equipment that is to be installed (which may be based at least on the types of installation work that are planned). Examples of additional or alternative information that may be derived from the engineering plan may include, but is not limited to, a bill of materials for the installation, a cost estimate for the installation, a time estimate for the installation, and/or a labor estimate for the installation. The bill of materials, time estimate and/or labor estimate may be based at least in part on details about the specific work which is planned (e.g., size of the work site, lengths of planned trenches, lengths utility infrastructure is to be installed, overall parts count of infrastructure to be installed, etc.).

For example, it may be known that performing a particular type of excavation, installing a particular type of utility (e.g., laying a particular type of cable), or more generally performing a particular type of installation of an engineered system, tends to proceed at a particular number of linear feet of installed infrastructure per minute, and/or costs some amount of money per linear foot of installed infrastructure; this fact may be combined with one or more of the planned type of excavation, the planned type of utility and/or installation, and planned length of utility infrastructure (e.g., pipe, cable, conduit) to be installed to generate a time and/or cost estimate for the installation.

As discussed in greater detail below, as part of installation activities the installation technician or crew 205 may add various “as-built” information to an engineering plan initially generated during pre-survey activity so as to provide comprehensive electronic documentation of pre-installation as well as installation activities (e.g., a “site visit manifest”). Based on such as-built information, actual values of estimated quantities (e.g., estimated time and/or costs for the installation) may be determined from, or included as part of, the as-built information. Such actual values for time and/or costs (associated with one or both of labor and materials associated with the installation) may be used for billing purposes; additionally, in some embodiments, actual values for time/costs may be compared to estimated values for quality control and/or cost assessment purposes.

Site Visit Manifests

The computing device 40 discussed above in connection with FIG. 6 further may be employed by one or both of the dispatch/locate technician or crew 207, and the installation technician or crew 205 (as well as other parties involved with or implicated by the installation process) to facilitate generation of a “site visit manifest” that electronically documents various aspects of one or both of pre-installation activity and installation activity in connection with installation of an engineered system.

As noted above, the term “site visit manifest” refers to any electronic information that may be generated and/or collected (e.g., by various field staff) in connection with any of multiple possible phases of a given installation of an engineered system at a particular work site. Examples of electronic information constituting at least a portion of a site visit manifest according to various inventive embodiments described herein include, but are not limited to: 1) a digital image of the work site; 2) location information (e.g., geographic coordinates) corresponding to one or more physical survey marks applied to ground, pavement or other surface during pre-survey activity (e.g., “white-lining”); 3) one or more digital representations of physical survey marks overlaid on a digital image of the work site to generate a marked-up digital image of the pre-survey activity; 4) one or more electronic survey marks or dig area indicators overlaid on a digital image of the work site as part of the pre-survey activity to indicate a location/locations at which the installation is planned; 5) an engineering plan for the installation (e.g., digital representations of one or more pieces of equipment to be installed at the work site, overlaid on a digital image of the work site); 6) excavation information relating to one or more types of excavation recommended for disturbing the ground, pavement or other surface to facilitate the installation; 7) locate and marking information generally relating to performance of the locate and marking operation; 8) more specific locate and marking information, such as location information (e.g., geographic coordinates) corresponding to one or more physical locate marks applied to ground, pavement or other surface during a locate and marking operation; 9) one or more digital representations of physical locate marks overlaid on a digital image of the work site to generate a marked-up digital image of the locate and marking operation; and 10) “as-built” information relating to the installation as completed.

In some embodiments relating to site visit manifests, various information components of a site visit manifest may be configured as independently-accessible and/or independently-viewable information “layers” of the site visit manifest. In one aspect, such information layers may be associated with different levels of permission or access-rights, so that different parties associated with the installation process may selectively view/access all or only some portions of the information constituting the site visit manifest. The various information constituting the site visit manifest may be electronically stored and/or electronically transmitted to various parties associated with the installation process to facilitate one or more of review of the work performed, quality, productivity and/or cost assessments of same, and billing functions.

In some embodiments, the dispatch/locate technician or crew 207 may prepare one portion of the site visit manifest during an initial visit to the work site at which pre-installation activity (a pre-survey and locate and marking operation) are performed; a site visit manifest electronically documenting pre-installation activity is sometimes referred to herein as a “preliminary site visit manifest.” An installation technician or crew 205 may prepare another portion of the site visit manifest during a subsequent visit to the work site to perform the installation (in some instances by adding “as-built” information to the previously-prepared preliminary site visit manifest). Accordingly, during multiple phases of an installation process, a site visit manifest may serve as a “living” electronic document, handed off to different field staff or other parties involved in the installation process, to memorialize various aspects of the installation process and create a useful record of same. To this end, essentially at any time during its generation (e.g., at different stages of information content) and/or upon completion of the site visit manifest, information relating to the site visit manifest may be electronically stored and/or electronically transmitted to various parties (e.g., the manifest itself, some portion thereof, or an electronic link to the site visit manifest may be stored and/or transmitted) to facilitate some aspect of the installation of the engineered system.

In one exemplary implementation, a digital image of the work site serves as a basis for a site visit manifest, to which one or both of additional image information and metadata are added relating to pre-installation and/or installation activity for an engineered system. For purposes of the present disclosure, a digital image is any image represented by source data that is electronically processed (e.g., the source data is in a computer-readable format) to display the image on a display device. A digital image may include any of a variety of paper/tangible image sources that are scanned (e.g., via an electronic scanner) or otherwise converted so as to create source data (e.g., in various formats such as XML, PDF, JPG, BMP, etc.) that can be processed to display the digital image. A digital image also may include an image that originates as source data or an electronic file without necessarily having a corresponding paper/tangible copy of the image (e.g., an image of a “real-world” scene acquired by a digital still frame or video camera or other image acquisition device, in which the source data, at least in part, represents pixel information from the image acquisition device).

In some implementations, digital images may be created, provided, and/or processed by a geographic information system (GIS) that captures, stores, analyzes, manages and presents data referring to (or linked to) location, such that the source data representing the digital image includes pixel information from an image acquisition device (corresponding to an acquired “real world” scene or representation thereof), and/or spatial/geographic information (“geo-encoded information”). In this manner, a GIS provides a framework for data manipulation and display of images that may facilitate one or more of (a) location verification, (b) location correlation, (c) locational relationships, (d) district coding, (e) route analysis, (f) area analysis and (g) mapping/display creation.

In view of the foregoing, various examples of digital images and source data representing input images according to the present disclosure, to which the inventive concepts disclosed herein may be applied, include but are not limited to:

Scanned manual “free-hand” paper sketches of the geographic area (which may include one or more buildings, natural or man-made landmarks, property boundaries, streets/intersections, public works or facilities such as street lighting, signage, fire hydrants, mail boxes, parking meters, etc.);

Various maps indicating surface features and/or extents of geographical areas, such as street/road maps, topographical maps, military maps, parcel maps, tax maps, town and county planning maps, call-center and/or facility polygon maps, virtual maps, etc. (such maps may or may not include geo-encoded information);

Facility maps illustrating installed underground facilities, such as gas, power, telephone, cable, fiber optics, water, sewer, drainage, etc. Facility maps may also indicate street-level features (streets, buildings, public facilities, etc.) in relation to the depicted underground facilities. Examples of facility maps include CAD drawings that may be created and viewed with a GIS to include geo-encoded information (e.g., metadata) that provides location information (e.g., infrastructure vectors) for represented items on the facility map;

Architectural, construction and/or engineering drawings and virtual renditions of a space/geographic area (including “as built” or post-construction drawings);

Land surveys, i.e., plots produced at ground level using references to known points such as the center line of a street to plot the metes and bounds and related location data regarding a building, parcel, utility, roadway, or other object or installation;

A grid (a pattern of horizontal and vertical lines used as a reference) to provide representational geographic information (which may be used “as is” for an input image or as an overlay for an acquired “real world” scene, drawing, map, etc.);

“Bare” data representing geo-encoded information (geographical data points) and not necessarily derived from an acquired/captured real-world scene (e.g., not pixel information from a digital camera or other digital image acquisition device). Such “bare” data may be nonetheless used to construct a displayed input image, and may be in any of a variety of computer-readable formats, including XML); and

Photographic renderings/images, including street level, topographical, satellite, and aerial photographic renderings/images, any of which may be updated periodically to capture changes in a given geographic area over time (e.g., seasonal changes such as foliage density, which may variably impact the ability to see some aspects of the image).

It should also be appreciated that source data representing an input image may be compiled from multiple data/information sources; for example, any two or more of the examples provided above for input images and source data representing input images, or any two or more other data sources, can provide information that can be combined or integrated to form source data that is electronically processed to display an image on a display device.

As noted above, in some implementations a digital image may be indexed to Global Positioning System (GPS) coordinates or another coordinate system that provides geo-spatial positioning. A digital image may include geo-coding or other geographical identification metadata and may be provided in any computer-readable format. A digital image may also include images of map symbols, such as roads and street names, that may be superimposed upon or displayed separately from an underlying geographic area when the digital image is displayed on a display device.

In some embodiments, a digital image serving as a basis for a site visit manifest may be appropriately selected (e.g., based on work site information included in the work order for the planned installation) and displayed on a computing device (e.g., the computing device 40 shown in FIG. 6) used by the dispatch/locate technician or crew 207 and/or the installation technician or crew 205. The displayed digital image may be electronically marked-up to include additional information relating to pre-installation and/or installation activity, and/or such additional information may be otherwise associated with the digital image (e.g., as metadata).

In various implementations, information may be added to the digital image “manually” (e.g., via one or more user input devices of the computing device), and/or automatically (e.g., with information received by the computing device via the device's communication interface). In some examples, information relating to pre-survey activities and/or locate and marking operations may be derived from a processor-based marking device, and the information from the marking device may be added to the digital image for purposes of generating a site visit manifest (e.g., a processor-based marking device employed by the dispatch/locate technician or crew 207 may be employed for one or both of pre-survey activity and a locate and marking operation, and may be communicatively coupled to a computing device 40 on which a site visit manifest is generated to automatically upload to the computing device the information from the marking device). Various concepts relating to adding information to a base digital image to generate searchable electronic records of locate and marking operations, for example, are discussed in detail in U.S. Publication No. 2011-0007076, published Jan. 13, 2011, corresponding to U.S. non-provisional application Ser. No. 12/831,330, filed on Jul. 7, 2010, entitled “Methods, Apparatus and Systems for Generating Searchable Electronic Records of Underground Facility Locate and/or Marking Operations,” which publication is hereby incorporated herein by reference in its entirety.

More specifically, in connection with pre-survey activity (e.g., dispatch, white-lining, generation of an engineering plan), as noted above if one or more physical survey marks are applied to ground, pavement or other surface as part of white-lining activity, one or more digital representations of such physical survey marks may be added to the digital image of the work site. Alternatively, as a surrogate for physical survey marks and electronic documentation relating to same, electronic survey marks may be added to the digital image of the work site (without applying physical survey marks) to indicate one or more locations at which the installation is planned. Additionally, to facilitate a locate request for the locate and marking operation, as discussed above one or more dig area indicators may be added to the digital image to precisely identify where some type of excavation is planned at the work site.

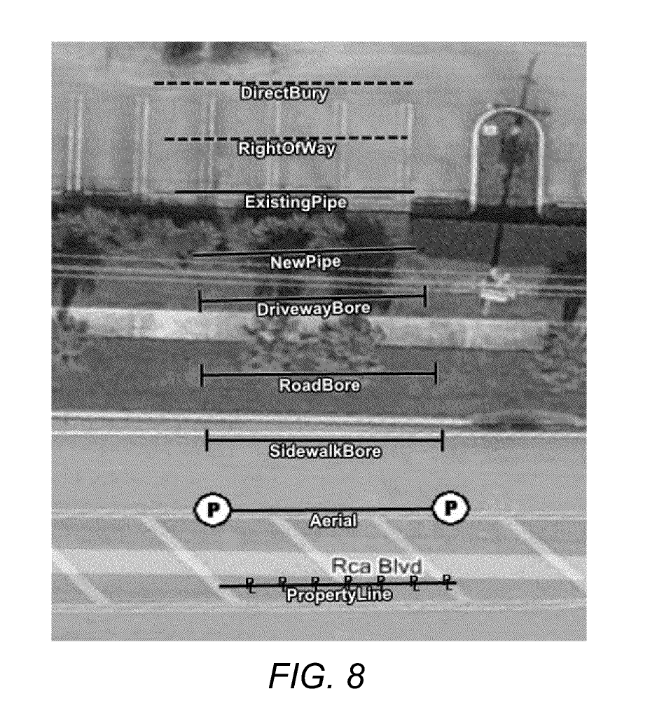

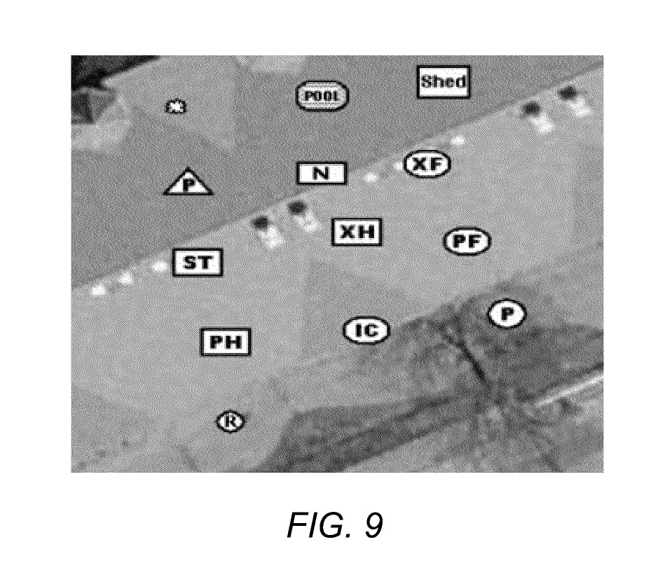

In another aspect of a site visit manifest, excavation information may be added to the digital image, and/or provided as metadata with the digital image, relating to one or more types of excavation recommended for disturbing the ground, pavement or other surface to facilitate the installation. For example, different types of excavation that may be recommended for a given installation include, but are not limited to, trenching (e.g., hand trenching, trenching with a drop plow, trenching with a back hoe), plowing (e.g., static plow, vibrating plow), combination trenching and plowing, boring (drilling), augering, and vacuum-based excavation (e.g., using air vacuums or water-jet vacuums). The excavation information added to the digital image and/or provided as metadata may include one or more of a text designation, a code, and a symbol for each type of excavation that may be recommended for a given installation. In particular, excavation information may be added to the digital image to indicate that in respective sections of a preferred path for an installation, a driveway bore, sidewalk bore, road bore, direct bury of the utility line, existing pipe, etc. should be used for performing the installation. Again, information about recommended excavation types may be indicated on the digital image itself by designations, codes and/or symbols, examples of which are discussed further below in connection with FIGS. 8 and 9.

As discussed in detail above, an engineering plan generated as part of the pre-survey activity also may serve as a constituent portion of a site visit manifest. Additionally, any locate and marking information relating to performance of the locate and marking operation at the work site may be added to the digital image and/or provided as metadata. A variety of possible types of locate and marking information that may be captured and/or generated during a locate and marking operation is discussed in detail in U.S. Publication No. 2010-0117654, published May 13, 2010, corresponding to U.S. non-provisional application Ser. No. 12/649,535, filed on Dec. 30, 2009, entitled “Methods and Apparatus for Displaying an Electronic Rendering of a Locate and/or Marking Operation Using Display Layers,” which publication is hereby incorporated herein by reference in its entirety. More specifically, one or more digital representations (“electronic locate marks”) corresponding to one or more physical locate marks applied to ground, pavement or other surface during a locate and marking operation may be added to the digital image so as to generate the site visit manifest. As noted above, in different implementations, such electronic locate marks may be marked-up on the digital image “manually” via one or more user input devices of a computing device, or added automatically to the digital image via upload of information from a processor-based marking device.

In another aspect of a site visit manifest, any constituent element of information included in a site visit manifest that relates to pre-installation activity may be used to determine time and/or cost estimates for the planned installation (e.g., an estimate of time and/or costs required to perform the installation). For example, as discussed above in connection with an engineering plan generated as part of a pre-survey, more generally various information in a site visit manifest relating to pre-installation activity may be used to generate a list of equipment that the installation technician or crew 205 is expected to need for the installation (including tools for use in the installation and/or equipment that is to be installed, which may be based at least on the types of excavation and/or installation work that are planned). Examples of additional or alternative information that may be derived from the site visit manifest may include, but is not limited to, a bill of materials for the installation, a cost estimate for the installation, a time estimate for the installation, and/or a labor estimate for the installation. As noted above, the bill of materials, time estimate and/or labor estimate may be based at least in part on details about the specific work which is planned (e.g., size of the work site, lengths of planned trenches, lengths utility infrastructure is to be installed, overall parts count of infrastructure to be installed, etc.). In one embodiment, estimated metrics for the planned installation may be based on one or more of a number of infrastructure elements to be installed as part of the installation, one or more types of excavation recommended for the installation, a length of at least one of the infrastructure elements to be installed, and a length of a linear excavation required for the installation.

In yet another aspect of a site visit manifest, respective elements of information included in a site visit manifest, relating to one or both of pre-installation activity or installation activity, may be arranged as “logical layers,” i.e., independently-accessible and/or independently-viewable information layers. Such logical layers may be configured in a variety of manners; for example, any information relating to pre-survey activity may be arranged in a “pre-survey layer,” which itself may include one or more sub-layers for respective information relating to white-lining (e.g., digital representations of physical survey marks, electronic survey marks), dig area indicators, excavation information, and/or an engineering plan. Similarly, locate and marking information relating to a locate and marking operation may be arranged in a “locate and marking layer,” which may include one or more sub-layers for various types of locate and marking information (e.g., digital representations of physical locate marks, or electronic locate marks).

With various elements of information contained in a site visit manifest organized as logical layers, information in layers may be selectively accessed and/or visually rendered on a display device (e.g., of the computing device 40 shown in FIG. 6), such that a viewer of the visual rendering may turn on and turn off displayed information based on the configuration of the logical layers (and any sub-layers). As noted above, examples of information categories that may be associated with corresponding display layers of a site visit manifest include, but are not limited to, “base image information” (maintaining the digital image serving as a basis of the site visit manifest as its own layer), “pre-survey information,” “locate and marking information,” and “as-built information” (discussed in greater detail below). Exemplary sub-layers of “pre-survey information” may include “white-lining,” “dig area indicator(s),” “excavation information,” and “engineering plan.” Exemplary sub-layers of “locate and marking information” may include “marking information” (e.g., information relating to applied physical locate marks and/or locate mark indicators representing same), “locate information” (e.g., information relating to detected underground facilities, and/or detection indicators representing same), “landmark information” (e.g., information relating to one or more landmarks in or near the dig area/work site and/or appearing in one or more images used in connection with the site visit manifest, and various symbols representing same), “labeling information” (e.g., information relating to labeling, annotations, notes, text boxes, etc. used in connection with an electronic manifest), and “revision information” (e.g., information relating to modifications to one or more elements constituting a site visit manifest). In some implementations, any of the layers or sub-layers may be selected for viewing (e.g., “turned on or off”), such that any layer or sub-layer may be viewed in isolation (or overlaid on the digital image), and such that any two or more layers may be simultaneously viewed (e.g., to facilitate a comparative analysis). Various concepts relating to independently-accessible and independently-viewable information layers in the context of locate and marking operations are discussed in detail in U.S. Publication No. 2010-0117654, published May 13, 2010, corresponding to U.S. non-provisional application Ser. No. 12/649,535, filed on Dec. 30, 2009, entitled “Methods and Apparatus for Displaying an Electronic Rendering of a Locate and/or Marking Operation Using Display Layers,” which publication is incorporated herein by reference in its entirety.

With respect to the mechanics of generating a site visit manifest, FIG. 8 shows various non-limiting examples of display elements that may be used (e.g., as provided by a drawing tool or program executed by the computing device 40 shown in FIG. 6) in representing different types of excavations and utility installations when electronically documenting pre-survey activities (e.g., generation of an engineering plan showing recommended work to be performed). The symbols shown in FIG. 8 also may be used in electronically documenting work that was performed as part of an installation (e.g., “as-built information”), as discussed further below in connection with FIG. 11. The display elements in FIG. 8 employ one or more of text descriptors, abbreviations or codes, icons and symbols to represent different types of excavation and/or installation (e.g., DirectBury, DrivewayBore, RoadBore, SidewalkBore, New Pipe, Aerial), as well as property lines and right-of-ways (easements).

Similarly to FIG. 8, FIG. 9 shows non-limiting examples of additional display elements (primarily symbols or icons) that may be used in representing on a marked-up digital image different types of existing and proposed structures that may be present at the work site, for documenting pre-installation or installation activities. In FIG. 9, the display elements are arranged in three columns: the display elements in the leftmost column, from top to bottom, represent a shrub, a power meter, a service terminal, a new hand hole, and a riser; the display element in the center column, from top to bottom, represent a pool, a network interface device, an existing hand hole, and an intercept of an existing conduit; and the display elements in the rightmost column, from top to bottom, represent a shed, an existing utility “flower pot,” a new utility “flower pot,” and a pole.

As noted above, the dispatch/locate technician or crew 207 may prepare one portion of the site visit manifest during an initial visit to the work site at which pre-installation activity (a pre-survey and locate and marking operation) are performed; a site visit manifest electronically documenting pre-installation activity is sometimes referred to herein as a “preliminary site visit manifest.” An installation technician or crew 205 may prepare another portion of the site visit manifest during a subsequent visit to the work site to perform the installation (in some instances by adding “as-built” information to the previously-prepared preliminary site visit manifest).

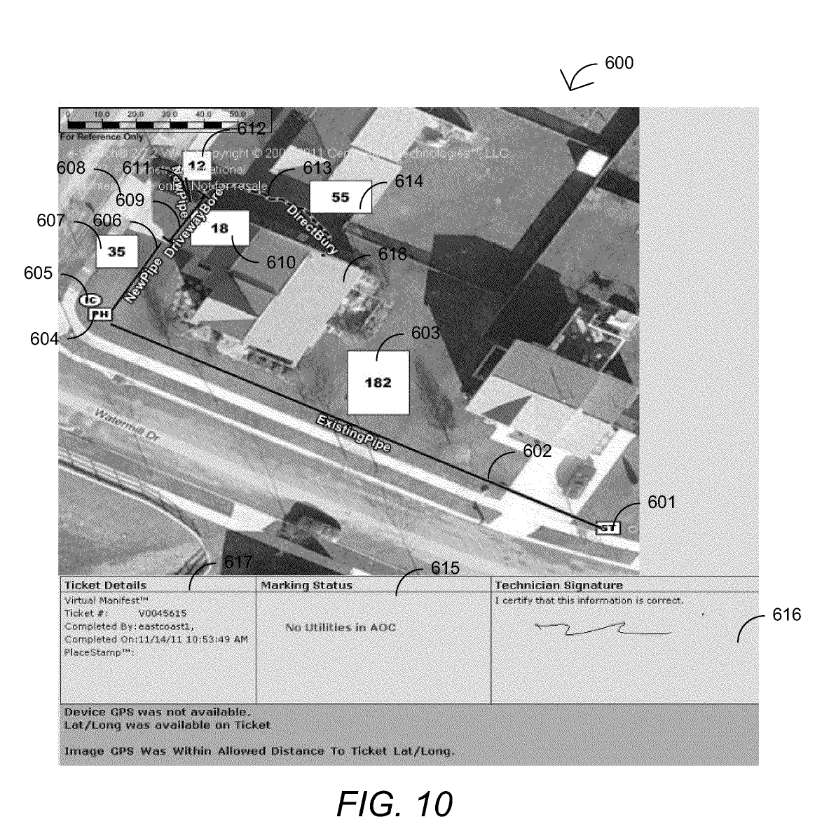

FIG. 10 illustrates an electronic site visit manifest 600 employing the various display elements shown in FIGS. 8 and 9, and showing a work site and various information documenting both pre-installation activities and installation activities relating to an engineered system (e.g., an FTTP installation) in accordance with embodiments of the present invention. In one implementation, an installation technician or crew 205 receives a preliminary site visit manifest (as part of a work order or accompanying a work order) that reflects electronic documentation of pre-installation activities, to which the installation technician or crew 205 adds “as-built information” to generate the site visit manifest. Regarding information received as part of the preliminary site visit manifest in connection with the locate and marking operation, block 615 of the site visit manifest 600 indicates that no previously-installed underground utilities were present at the work site. Ticket information relating to the locate request ticket received from the one-call center 209 are present in block 617.

The site visit manifest 600 shown in FIG. 10 indicates that starting at service terminal 601, there was an existing pipe 602 to which a new portion of the engineered system was installed. Box 603 indicates that the existing pipe 602 was 182 feet long. At the other end of existing pipe 602, a new hand hole 604 was installed for accessing the existing pipe, and a new pipe 606 connected to existing pipe 602 at intercept connect 605. Box 607 indicates that the new pipe 606 was 35 feet long. At the end of new pipe 606 the installation ran into a driveway 608, so a driveway bore 609 was used from that point. Box 610 indicates that the driveway bore 609 was 18 feet long. On the other end of the driveway bore 609, a new pipe 611 connected to the driveway bore 609. Box 612 indicates that the new pipe 611 was 12 feet long. From the end of new pipe 611, the utility to be installed (e.g., an FTTP subscriber drop 613) was buried directly, and box 614 indicates that the section of the direct bury 613 was 55 feet long. At the end of the direct bury 614, the installation ends at the house 618. Box 616 illustrates that, upon completion of the site visit manifest to add as-built information, an installation technician (or representative member of the installation crew) may electronically sign the site visit manifest to certify the information contained therein is correct.

Installation Activities and Documentation of Same

FIG. 11 is a flow diagram illustrating an exemplary method 300 according to one embodiment of the present invention for conducting installation activity relating to an installation of an engineered system. As noted above, an installation technician or crew 205 is commissioned to perform installation activities following pre-installation activities and to this end, as indicated in block 301, a work order (including work site information) is transmitted (e.g., electronically) by the installation contractor 203 and received by the installation technician or crew (e.g., electronically via a computing device 40). The work order may itself include a preliminary site visit manifest generated by the dispatch/locate technician or crew 207, or the work order may be accompanied by a separately transmitted/received preliminary site visit manifest.

When an installation technician or crew 205 arrives to perform the installation, any physical locate marks applied during the locate and marking operation can provide a visible indication of areas where the installation technician/crew should avoid digging so as not to disturb any previously-installed/pre-existing underground facilities. In some cases, the locate and marking operation will determine that no pre-existing underground facilities are located in the areas that were identified during the pre-survey for excavation and/or indicated for planned installation. If, however, pre-existing underground facilities are located and marked within areas where excavation would have been indicated based on the pre-survey, the installation may need to be performed according to an altered approach. In some cases, the installation technician or crew 205 may analyze both the pre-survey and the physical locate marks and determine an alternative installation plan accordingly.

At block 305, the installation technician or crew 205 performs the installation, including any excavation that may be necessary attendant to the installation, and at block 307 the installation technician or crew 205 add as-built information to the preliminary site visit manifest (e.g., via computing device 40) so as to generate a site visit manifest of the completed installation. As discussed above, in some embodiments, the as-built information may be added to the preliminary site visit manifest as a logical information layer, and such an as-built information layer may include one or more logical information sub-layers relating to the as-built information. At block 309, information relating to the site visit manifest is electronically stored (in storage 47 of the computing device 40) and/or electronically transmitted (e.g., via the communication interface 44 of the computing device 40) so as to provide a searchable electronic record of the installation.

As discussed above in connection with estimates of time and costs relating to the installation (based on information relating to pre-installation activity documented in a preliminary site visit manifest), information relating to actual time and costs associated with completing the installation similarly may be derived from a site visit manifest including as-built information, and such information may be used to facilitate generation of an invoice for the installation. For example, one or more of a bill of materials used for the installation, a materials cost for the installation, a time spent on the installation, and a labor cost for the installation may be derived from the as-built information, and in some implementations included as part of the information contained in the site visit manifest. In one embodiment, actual metrics for the completed installation may be based on one or more of a number of infrastructure elements installed, one or more types of excavation used for the installation, a length of at least one of the infrastructure elements installed, and a length of a linear excavation required for the installation.

In another embodiment relating to installation activities and documenting of same, as-built information included in a site visit manifest may be electronically compared to at least some of the information in a preliminary site visit manifest (e.g., information relating to one or both of pre-survey activity and a locate and marking operation) to provide one or more electronic indications of a quality, productivity and/or cost assessment of the installation of the engineered system. Various criteria and metrics may be employed for such an assessment; for example, pre-survey information indicating where an engineered system or a portion thereof should be installed, and/or a type of excavation to be employed in the installation, may be compared to actual locations of the installed infrastructure (e.g., how far from the locations recommended in the pre-survey), and/or the types of excavation techniques actually employed in the installation. Similarly, one or more estimated metrics for the installation (e.g., an equipment list, a bill of materials, a cost estimate, a time estimate, a labor estimate) may be compared to actual metrics for the installation (e.g., a bill of materials used, a materials cost, a time spent, a labor cost) to provide one or more electronic indications of a quality, productivity and/or cost assessment (e.g., an indication of whether or not the estimate of time and/or cost was sufficiently close to the actual time and/or cost for the installation). Various concepts relating to quality assessment of a locate and marking operation, some of which concepts may similarly be applicable to a quality, productivity and/or cost assessment of an installation of an engineered system or a portion thereof, are described in detail in U.S. Publication No. 2009-0327024, published Dec. 31, 2009, corresponding to U.S. non-provisional application Ser. No. 12/493,109, filed on Jun. 26, 2009, entitled “Methods and Apparatus for Quality Assessment of a Field Service Operation,” which publication is incorporated by reference herein in its entirety.

Example Installation and Information Flow

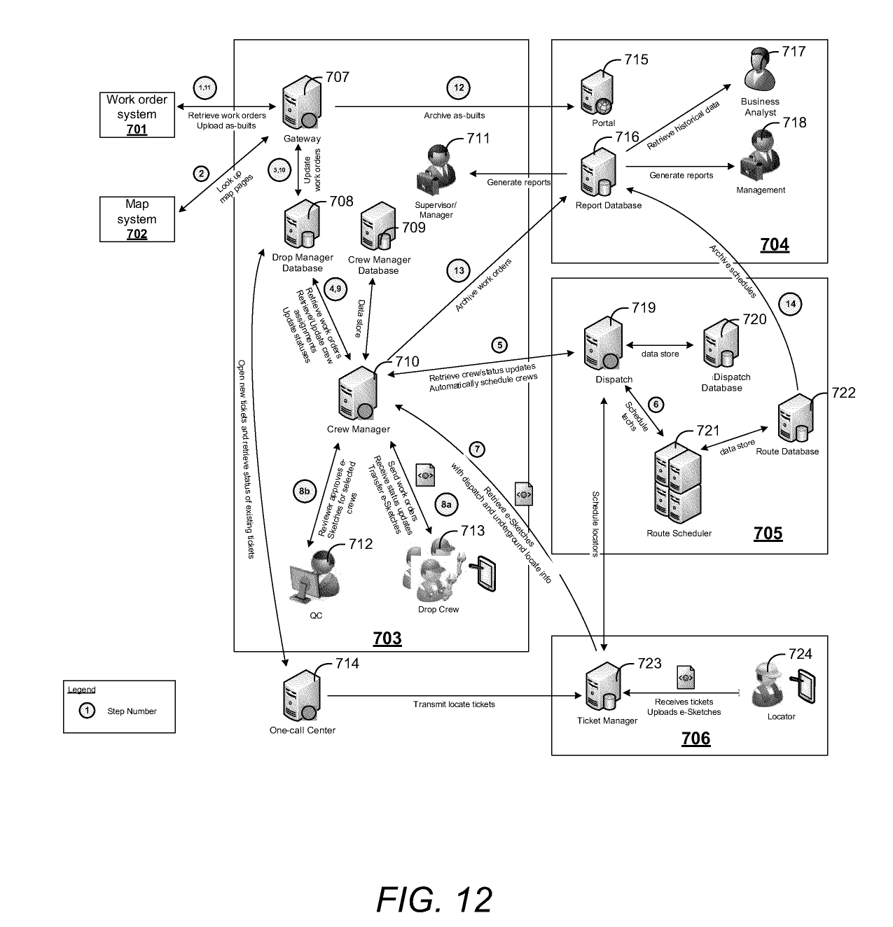

FIG. 12 illustrates a method for processing work orders and generating site visit manifests of work performed pursuant to work orders in accordance with embodiments of the present invention. The method of FIG. 12 relates primarily to FTTP installations of subscriber drops as performed by a “drop crew” serving as an installation crew 205. In FIG. 12, various versions of site visit manifests documenting different phases of the pre-installation and installation activity are referred to for simplicity as “e-Sketches” (i.e., electronic sketches). Also, various entities involved in the installation process may include computing equipment (e.g., processors, servers, memory storage, display devices, user interfaces/portals, etc.) which is shown in FIG. 12 using a generic icon for various types of computing equipment.

In FIG. 12, work orders originate at work order system 701. The work order system 701 may be operated by, e.g., a utility company 201 as shown in FIG. 2, and may be used to transmit work orders requesting performance of a utility installation. A work order is received at installation company 703 by gateway 707, which contacts map system 702 to retrieve map information relating to the work order. The map information may be, for example, aerial digital imagery corresponding to a residential address provided in the work order. The map information also may include map grid coordinates indicating where on a specified map the work order address is to be found. Gateway 707 can then update the work order with the map information and transmit the updated work order to drop manager database 708. In some cases, drop manager database 708 may transmit information relating to the work order to one-call center 714 to request a locate ticket. In other cases, locator 724 may request a locate ticket from one-call center 714, e.g., while present at the work site. One-call center 714 processes the locate ticket request and transmits the locate ticket to a locate provider 706, where it is received in Ticket Manager 723, from where the ticket can be provided to locator 724.

With reference again to drop manager database 708, the work order is transmitted further to crew manager 710. Crew manager 710 transmits information to scheduler 705, where the information is received at Dispatch 719. The information is then stored in Dispatch Database 720 and transmitted to Route Scheduler 721, which uses the information to schedule one or more field staff to handle the work order. The scheduling information is stored in Route Database 722, which in turn transmits the scheduling information for archiving at a data analysis center 704, where it is received in Report Data Base 716. The data is then available for future analysis by a business analyst 717 who may retrieve historical data for analysis, or by management 718 who may receive reports generated by Report Data Base 716. Reports also may be generated and sent to a supervisor/manager 711 at the installation company 703.

With reference again to Dispatch 719, locator scheduling information is transmitted to Ticket Manager 723 which manages locators 724. When a locator 724 has completed field operations including a locate operation, the locator 724 transmits an electronic manifest including information documenting the field operations, such as dispatch and underground locate information (e.g., a “preliminary site visit manifest”), to Ticket Manager 723. The electronic manifest is then transmitted from Ticket Manager 723 to Crew Manager 710. Crew Manager 710 transmits the work order, as well as the electronic manifest, to Drop Crew 713, which can then proceed to complete the utility installation using the information in the work order and the electronic manifest. The Drop Crew 713 provides updates Crew Manager 710 regarding the status of the installation, and also may provide an updated electronic manifest including information documenting the work done by the Drop Crew 713 during the installation.

Upon receipt of the electronic manifest from Ticket Manager 723, and also upon receipt of the updated electronic manifest from the Drop Crew 713 (e.g., a completed site visit manifest), Crew Manager 710 also can provide the electronic manifest and/or information relating to the electronic manifest to a quality control operator/quality control system 712, which reviews and can approve the electronic manifest based on quality control criteria (as well as productivity and/or cost criteria). Information relating to the quality control evaluation may be transmitted back to Crew Manager 710, as well.

Crew Manager 710 transmits the work order to Report Data Base 716 for archiving, and also transmits the work order and updated information relating to the work order, including the electronic manifest, to Drop Manager Database 708, which in turn transmits the information to Gateway 707. From Gateway 707, the information is sent to Portal 715 for archiving, and also is transmitted to work order system 701 which originally submitted the work order.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of performing an underground utility installation at a work site and generating a site visit manifest for the underground utility installation as completed to provide a searchable electronic record of the underground utility installation, the method comprising:
A) electronically receiving a preliminary site visit manifest for the underground utility installation, the preliminary site visit manifest comprising a digital image of the work site and at least one image information layer overlaid on the digital image, the at least one image information layer comprising at least one of:
A1) pre-survey information indicating a planned location at the work site for the underground utility installation; and
A2) locate and marking information relating to performance of a locate and marking operation at the work site, the locate and marking operation including determining a presence or an absence of at least one previously-installed underground facility at the work site and applying at least one physical locate mark to ground, pavement, or other surface at the work site to indicate the presence or the absence of the at least one previously-installed underground facility;
B) performing the underground installation at the work site, based at least in part on the preliminary site visit manifest received in A);
C) generating the site visit manifest by electronically updating the preliminary site visit manifest to include at least one additional image information layer to be overlaid on the digital image, the at least one additional image information layer including as-built information relating to the underground utility installation as completed pursuant to B); and
D) electronically transmitting and/or electronically storing information relating to the site visit manifest generated in C) so as to provide the searchable electronic record of the underground utility installation.

2. The method of claim 1, wherein the underground utility installation is a fiber-to-the-premises (FTTP) installation.

3. The method of claim 1, further comprising:
E) electronically generating at least one of a bill of materials used for the underground utility installation, a materials cost for the underground utility installation, a time spent on the underground utility installation, and a labor cost for the underground utility installation, based at least in part on the as-built information in C), so as to facilitate generation of an invoice for the underground utility installation,
wherein the site visit manifest includes the at least one of the bill of materials, the materials cost, the time spent, and the labor cost for the underground utility installation.

4. The method of claim 3, wherein E) comprises electronically generating at least one of the bill of materials used for the underground utility installation, the materials cost for the underground utility installation, the time spent on the underground utility installation, and the labor cost for the underground utility installation based on at least one of:
a number of infrastructure elements installed as part of the underground utility installation;
one or more types of excavation required for the underground utility installation;
a first length of at least one of the infrastructure elements installed as part of the underground installation; and
a second length of a linear excavation required for the underground utility installation.

5. The method of claim 1, wherein A) comprises:
electronically receiving a work order for the underground utility installation, wherein the work order comprises the preliminary site visit manifest.

6. The method of claim 5, further comprising:
electronically updating a status of the work order during or following B).

7. The method of claim 1, wherein:
in A), the preliminary site visit manifest includes both the pre-survey information and the locate and marking information; and
the preliminary site visit manifest includes a plurality of independently-viewable and independently-accessible information layers to be overlaid on the digital image, wherein:
a first information layer of the plurality of information layers includes the pre-survey information; and
a second information layer of the plurality of information layers includes the locate and marking information.

8. The method of claim 7, wherein in A1), the pre-survey information comprises at least one of:
at least one first digital representation corresponding to at least one physical survey mark applied to ground, pavement or other surface at the work site to indicate the planned location for the underground utility installation;
at least one electronic survey mark to indicate the planned location for the underground utility installation;
excavation information relating to a type of excavation recommended for disturbing the ground, pavement or other surface to facilitate the underground utility installation; and
an engineering plan for the underground utility installation.

9. The method of claim 7, wherein in A2), the locate and marking information comprises:
at least one electronic locate mark corresponding to the at least one physical locate mark applied to the ground, pavement or other surface at the work site to indicate the presence or the absence of the at least one previously-installed underground facility.

10. The method of claim 7, wherein in C), the site visit manifest includes:
the first information layer including the pre-survey information;
the second information layer including the locate and marking information; and
a third independently-viewable and independently-accessible information layer including the as-built information.

11. The method of claim 1, wherein D) comprises electronically transmitting a link to the site visit manifest.

12. The method of claim 11, wherein the site visit manifest further comprises at least one of:
a bill of materials used for the underground utility installation;
a materials cost for the underground utility installation;
a time spent on the underground utility installation; and
a labor cost for the underground utility installation.

13. The method of claim 1, further comprising:
E) electronically comparing the as-built information and at least some information in the preliminary site visit manifest to provide at least one electronic indication of a quality, productivity and/or cost assessment of the underground utility installation.

14. The method of claim 13, wherein E) comprises electronically comparing the as-built information to both of the pre-survey information and the locate and marking information so as to provide the at least one electronic indication of the quality, productivity and/or cost assessment of the underground utility installation.

15. The method of claim 13, wherein:
the preliminary site visit manifest received in A) includes at least one estimated metric for the underground utility installation, the at least one estimated metric including at least one of: an equipment list;
a bill of materials;
a cost estimate;
a time estimate; and
a labor estimate for the underground utility installation;
the site visit manifest includes at least one actual metric for the underground utility installation, the at least one actual metric including at least one of:
a bill of materials used for the underground utility installation;
a materials cost for the underground utility installation;
a time spent on the underground utility installation; and
a labor cost for the underground utility installation; and
E) comprises electronically comparing the at least one estimated metric and the at least one actual metric so as to provide the at least one electronic indication of the quality, productivity and/or cost assessment of the underground utility installation.

16. A method of performing a fiber-to-the-premises (FTTP) installation at a work site and generating a site visit manifest for the FTTP installation as completed to provide a searchable electronic record of the FTTP installation, the method comprising:
A) electronically receiving a work order for the FTTP installation, the work order comprising a preliminary site visit manifest for the FTTP installation, the preliminary site visit manifest comprising a digital image of the work site and a plurality of image information layers overlaid on the digital image, the plurality of image information layers comprising:
A1) pre-survey information indicating a planned location at the work site for the FTTP installation; and
A2) locate and marking information relating to performance of a locate and marking operation at the work site, the locate and marking operation including determining a presence or an absence of at least one previously-installed underground facility at the work site and applying at least one physical locate mark to ground, pavement, or other surface at the work site to indicate the presence or the absence of the at least one previously-installed underground facility, the locate and marking information including at least one electronic locate mark corresponding to the at least one physical locate mark;
B) performing the FTTP installation at the work site, based at least in part on the work order received in A);
C) generating the site visit manifest by electronically updating the preliminary site visit manifest to include at least one additional image information layer to be overlaid on the digital image, the at least one additional image information layer including as-built information relating to the FTTP installation as completed pursuant to B); and
D) electronically transmitting and/or electronically storing information relating to the site visit manifest generated in C) so as to provide the searchable electronic record of the FTTP installation.

17. An apparatus for generating a site visit manifest for an underground utility installation as completed to provide a searchable electronic record of the underground utility installation, the apparatus comprising:
a communication interface;
a display device;
a user input device;
a memory to store processor-executable instructions; and
a processor coupled to the communication interface, the display device, the user input device, and the memory, wherein upon execution of the processor-executable instructions by the processor, the processor:
A) controls the communication interface to receive a preliminary site visit manifest for the underground utility installation, the preliminary site visit manifest comprising a digital image of the work site and at least one image information layer to be overlaid on the digital image, the at least one image information layer comprising at least one of:
A1) pre-survey information indicating a planned location at the work site for the underground utility installation; and
A2) locate and marking information relating to performance of a locate and marking operation at the work site, the locate and marking operation including determining a presence or an absence of at least one previously-installed underground facility at the work site and applying at least one physical locate mark to ground, pavement, or other surface at the work site to indicate the presence or the absence of the at least one previously-installed underground facility;
B) controls the display device to display the preliminary site visit manifest received in A);
C) receives, via at least one of the communication interface and the user input device, as-built information relating to the underground utility installation as completed; and
D) generates the site visit manifest by electronically updating the preliminary site visit manifest to include at least one additional image information layer to be overlaid on the digital image, the at least one additional image information layer including the as-built information received in C); and
E) controls at least one of the communication interface and the memory to electronically transmit and/or electronically store information relating to the site visit manifest generated in D) so as to provide the searchable electronic record of the underground utility installation.

18. The apparatus of claim 17, wherein the processor further controls the display device to display the site visit manifest generated in D).

19. The apparatus of claim 17, wherein the processor further:
F) generates at least one of a bill of materials used for the underground utility installation, a materials cost for the underground utility installation, a time spent on the underground utility installation, and a labor cost for the underground utility installation, based at least in part on the as-built information received in C), so as to facilitate generation of an invoice for the underground utility installation,
wherein the site visit manifest includes the at least one of the bill of materials, the materials cost, the time spent, and the labor cost for the underground utility installation.

20. The apparatus of claim 19, wherein in F), the processor generates at least one of the bill of materials used for the underground utility installation, the materials cost for the underground utility installation, the time spent on the underground utility installation, and the labor cost for the underground utility installation based on at least one of:
a number of infrastructure elements installed as part of the underground utility installation;
one or more types of excavation required for the underground utility installation;
a first length of at least one of the infrastructure elements installed as part of the underground installation; and
a second length of a linear excavation required for the underground utility installation.

21. The apparatus of claim 17, wherein in A), the processor controls the communication interface to receive a work order for the underground utility installation, wherein the work order comprises the preliminary site visit manifest.

22. The apparatus of claim 21, wherein the processor further controls the communication interface to update a status of the work order during or following the underground utility installation based at least in part on user input received via the user input device.

23. The apparatus of claim 17, wherein:
in A), the preliminary site visit manifest includes both the pre-survey information and the locate and marking information; and
the preliminary site visit manifest includes a plurality of independently-viewable and independently-accessible information layers to be overlaid on the digital image, wherein:
a first information layer of the plurality of information layers includes the pre-survey information; and
a second information layer of the plurality of information layers includes the locate and marking information.

24. The apparatus of claim 23, wherein in A1), the pre-survey information comprises at least one of:
at least one first digital representation corresponding to at least one physical survey mark applied to ground, pavement or other surface at the work site to indicate the planned location for the underground utility installation;
at least one electronic survey mark to indicate the planned location for the underground utility installation;
excavation information relating to a type of excavation recommended for disturbing the ground, pavement or other surface to facilitate the underground utility installation; and
an engineering plan for the underground utility installation.

25. The apparatus of claim 23, wherein in A2), the locate and marking information comprises:
at least one electronic locate mark corresponding to the at least one physical locate mark applied to the ground, pavement or other surface at the work site to indicate the presence or the absence of the at least one previously-installed underground facility.

26. The apparatus of claim 23, wherein in C), the site visit manifest includes:
the first information layer including the pre-survey information;
the second information layer including the locate and marking information; and
a third independently-viewable and independently-accessible information layer including the as-built information.

27. The apparatus of claim 26, wherein the processor further:
F) controls the display device to display the site visit manifest generated in D).

28. The apparatus of claim 27, wherein in F), the processor further controls the display device to display respective layers of the plurality of independently-viewable and/or independently accessible information layers based at least in part on user input received from the user input device and a corresponding information access authorization indication.

29. The apparatus of claim 17, wherein in E), the processor controls the communication interface to transmit a link to the site visit manifest.

30. The apparatus of claim 29, wherein the site visit manifest further comprises at least one of:
a bill of materials used for the underground utility installation;
a materials cost for the underground utility installation;
a time spent on the underground utility installation; and
a labor cost for the underground utility installation.

31. The apparatus of claim 17, wherein the processor further:
F) compares the as-built information and at least some information in the preliminary site visit manifest to provide at least one electronic indication of a quality, productivity and/or cost assessment of the underground utility installation.

32. The apparatus of claim 31, wherein in F), the processor compares the as-built information to both of the pre-survey information and the locate and marking information so as to provide the at least one electronic indication of the quality, productivity and/or cost assessment of the underground utility installation.

33. The apparatus of claim 31, wherein:
the preliminary site visit manifest received in A) includes at least one estimated metric for the underground utility installation, the at least one estimated metric including at least one of:
an equipment list;
a bill of materials;
a cost estimate;
a time estimate; and
a labor estimate for the underground utility installation;
the site visit manifest includes at least one actual metric for the underground utility installation, the at least one actual metric including at least one of:
a bill of materials used for the underground utility installation;
a materials cost for the underground utility installation;
a time spent on the underground utility installation; and
a labor cost for the underground utility installation; and
in F), the processor compares the at least one estimated metric and the at least one actual metric so as to provide the at least one electronic indication of the quality, productivity and/or cost assessment of the underground utility installation.

34. A computer readable storage medium storing processor-executable instructions that, when executed by at least one processor, perform a method for generating a site visit manifest for an underground utility installation as completed to provide a searchable electronic record of the underground utility installation, the method comprising:
A) electronically receiving a preliminary site visit manifest for the underground utility installation, the preliminary site visit manifest comprising a digital image of the work site and at least one image information layer to be overlaid on the digital image, the at least one image information layer comprising at least one of:
A1) pre-survey information indicating a planned location at the work site for the underground utility installation; and
A2) locate and marking information relating to performance of a locate and marking operation at the work site, the locate and marking operation including determining a presence or an absence of at least one previously-installed underground facility at the work site and applying at least one physical locate mark to ground, pavement, or other surface at the work site to indicate the presence or the absence of the at least one previously-installed underground facility;
B) electronically receiving as-built information relating to the underground utility installation as completed;
C) electronically generating the site visit manifest by electronically updating the preliminary site visit manifest to include at least one additional image information layer to be overlaid on the digital image, the at least one additional image information layer including the as-built information received in B); and
E) electronically transmitting and/or electronically storing information relating to the site visit manifest generated in C) so as to provide the searchable electronic record of the underground utility installation.
